(19) United States
(12) Patent Application Publication
(10) Pub. No.: US 2004/0171405 A1
(43) Pub. Date: Sep. 2, 2004

(54) Information processing apparatus, information processing method and program

(75) Inventors: Ryoko Amano, Tokyo (JP); Shoko Hiroyasu, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/731,248

(22) Filed: Dec. 10, 2003

(30) Foreign Application Priority Data
Jan. 8, 2003 (JP) 2003-002293
Jan. 8, 2003 (JP) 2003-002294

(51) Int. Cl. H04B 7/00; H04Q 7/20

(52) U.S. Cl. 455/556.2; 455/525

(57) ABSTRACT

An information processing apparatus and method is disclosed by which processes relating to recording and displaying of use history information of an IC card can be performed suitably and safely. A CPU activates an application and changes over its mode from an off mode to a polling mode, in which it controls a reader device to detect a contactless IC card positioned near to the reader device. In response to detection of the contactless IC card, the CPU enters into a balance display mode, in which it displays balance information of the contactless IC card for a predetermined period of time. Then, in response to an instruction of a user, the CPU enters a history display-storage mode, in which it displays or stores history information of the contactless IC card into a database. Further, in response to another instruction of the user in the polling mode, the CPU enters into a history deletion mode, in which deletion of history information is performed. The invention can be applied to a PDA.

### BACKGROUND OF THE INVENTION

This invention relates to an information processing apparatus, information processing method and program, and more particularly to an information processing apparatus, information processing method and program which involve execution of a process relating to recording and display of use history information of an IC card.

In recent years, a commercial transaction method has been popularized which does not use metallic or paper currency but uses a credit card, a prepaid card or the like. One of such methods is a commercial transaction method which uses an IC (Integrated Circuit) card.

An IC card typically is a plastic card which has a size substantially equal to that of a cash card and has a very thin semiconductor integrated circuit in the form of an IC chip embedded therein. The IC card has functions of a CPU (Central Processing Unit), a ROM (Read Only memory) and/or a RAM (Random Access Memory) so that information can be recorded into the same. The IC card allows recording of several K byte data into the built-in memory thereof and allows encryption of data and hence is tough against falsification. Therefore, the IC card is applied typically as a recording medium such as electronic money or a telephone card.

IC cards are classified into the “contact type” and the “contactless type” depending upon the difference in the data reading and writing method. A contact type card communicates data with a terminal through contacts provided on the card side. Meanwhile, a contactless type card has a built-in antenna and makes use of a weak radio wave to perform short-range communication with a terminal.

In such IC cards as described above, history information of a predetermined number of transactions performed recently is recorded. In order for a user to read such history information from an IC card, for example, a history information reading apparatus may be used. The history information reading apparatus is configured such that, when the user operates the IC card so as to contact with or approach a card reader for exclusive use which can read out information from an IC card, history information is acquired from the IC card through the card reader and displayed on a display unit. A history information reading apparatus of the type described is disclosed, for example, in “EdyViewer Help”, [download data (self-extracting type compressed file)], Sep. 11, 2002, BitWallet,Inc. [searched Jan. 6, 2003], Internet, <http://www.bitwallet.co.jp/user/download/index.html>, application data “EdyViewer”, <http://www.bitwallet.co.jp/user/download/edyvw1013.exe>, HTML data, <¥EdyView¥Help¥index.htm>(hereinafter referred to as Non-Patent Document 1).

The history information reading apparatus disclosed in the Non-Patent Document 1, however, has a problem in that, for example, if the user leaves the seat while history information remains displayed on the display unit, then there is the possibility that the history information displayed on the display unit may be read by a third party other than the user, resulting in leak of the personal information.

Further, although the history information reading apparatus is ready only for an IC card of a particular type and can read history information of the IC card, it does not discriminate an IC card of any other type as an IC card. However, a great number of IC cards are available, and a user who owns a plurality of different IC cards may possibly operate an inappropriate IC card to move near to the IC card reader. In such an instance, when the history information reading apparatus discriminates a nearly positioned IC card as an inappropriate card, it preferably notify the user that an inappropriate card is positioned nearly to the card reader in a distinguishable manner from that in another case wherein no IC card is positioned nearly so that the user may accurately specify a cause of an error.

### SUMMARY OF THE INVENTION

It is an object of the present invention to provide an information processing apparatus, information processing method and program by which a process relating to recording and display of use history information of an IC card can be executed suitably and safely.

In order to attain the object described above, according to an aspect of the present invention, there is provided an information processing apparatus which communicates with an IC card, on which information can be recorded, to read out information recorded in the IC card, including information acquisition means for acquiring the information recorded in the IC card, information storage means for storing the information acquired by the information acquisition means, information processing means for performing a predetermined process for the information, and information display control means for controlling display of the information acquired by the information acquisition means.

According to another aspect of the present invention, there is provided an information processing method for an information processing apparatus which communicates with an IC card, on which information can be recorded, to read out information recorded in the IC card, including an information acquisition step of acquiring the information recorded in the IC card, an information storage step of storing the information acquired by the process of the information acquisition step, an information processing step of performing a predetermined process for the information, and an information display control step of controlling display of the information acquired by the process of the information acquisition step.

According to a further aspect of the present invention, there is provided a program for causing a computer to perform a process of communicating with an IC card, on which information can be recorded, to read out information recorded in the IC card, the program including an information acquisition step of acquiring the information recorded in the IC card, an information storage step of storing the information acquired by the process of the information acquisition step, an information processing step of performing a predetermined process for the information, and an information display control step of controlling display of the information acquired by the process of the information acquisition step.

According to a still further aspect of the present invention, there is provided an information processing apparatus which communicates with an IC card, on which information can be recorded, to read out information recorded in the IC card, including IC card detection means for detecting the IC card which is in a communicatable state, type detection means for detecting a type of the IC card detected by the IC card detection means, information acquisition means for acquiring the information stored in the IC card if a result of the discrimination by the type discrimination means indicates that the IC card is a legal type card, and information display control means for controlling display of the information acquired by the information acquisition means.

According to a still further aspect of the present invention, there is provided an information processing method for an information processing apparatus which communicates with an IC card, on which information can be recorded, to read out information recorded in the IC card, including an IC card detection step of detecting the IC card which is in a communicatable state, a type discrimination step of discriminating a type of the IC card detected by the process of the IC card detection step, an information acquisition control step of acquiring the information stored in the IC card if a result of the discrimination by the process of the type discrimination step indicates that the IC card is a legal type card, and an information display control step of controlling display of the information acquired by the process of the information acquisition control step.

According to a yet further aspect of the present invention, there is provided a program for causing a computer to communicate with an IC card, on which information can be recorded, to read out information recorded in the IC card, the program including an IC card detection step of detecting the IC card which is in a communicatable state, a type discrimination step of discriminating a type of the IC card detected by the process of the IC card detection step, an information acquisition control step of acquiring the information stored in the IC card if a result of the discrimination by the process of the type discrimination step indicates that the IC card is a legal type card, and an information display control step of controlling display of the information acquired by the process of the information acquisition control step.

In the information processing apparatus, information processing method and the program, an IC card which is in a communicatable state is detected, and the type of the detected IC card is discriminated. Then, if a result of the discrimination indicates that the IC card is of an appropriate type, information recorded in the IC card is acquired, and display of the acquired information is controlled.

With the information processing apparatus, information processing method and the program, information can be recorded, managed and displayed. Particularly, processes relating to recording and displaying of use history information of an IC card can be executed suitably and safely.

According to a yet further aspect of the present invention, there is provided an information processing apparatus which communicates with an IC card, on which information can be recorded, to read out information recorded in the IC card, including information acquisition means for acquiring the information recorded in the IC card, information storage means for storing the information acquired by the information acquisition means, information management control means for managing the information stored in the information storage means as information of the individual IC card and controlling readout and writing of the information from and into the information storage means, and information display control means for controlling display of the information.

According to a yet further aspect of the present invention, there is provided an information processing method for an information processing apparatus which communicates with an IC card, on which information can be recorded, to read out information recorded in the IC card, including an information acquisition control step of acquiring the information recorded in the IC card, an information management control step of managing the information acquired under the control of the process of the information acquisition control step and stored in a storage section of the information processing apparatus as information of the individual IC card and controlling readout and writing of the information from and into the storage section, and an information display control step of controlling display of the information.

According to a yet further aspect of the present invention, there is provided a program for causing a computer to communicate with an IC card, on which information can be recorded, to read out information recorded in the IC card, the program including an information acquisition control step of managing the information acquisition recorded in the IC card, an information management control step of managing the information acquired under the control of the process of the information acquisition control step and stored in a storage section of the information processing apparatus as information of the individual IC card and controlling readout and writing of the information from and into the storage section, and an information display control step of controlling display of the information.

In the information processing apparatus, information processing method and the program, information recorded in an IC card is acquired, and the acquired information is stored. Then, the stored information is managed as information of the individual IC card, and reading out and writing of information into and from the IC card is controlled.

With the information processing apparatus, information processing method and the program, information can be recorded, managed and displayed. Particularly, processes relating to recording and displaying of use history information of an IC card can be executed suitably and safely.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a perspective view showing a configuration of the front of a PDA (Personal Digital Assistant) to which the present invention is applied;

FIG. 2 is a view showing an example of an image displayed on an LCD (Liquid Crystal Display) unit of the PDA of FIG. 1;

FIG. 3 is a view showing an example of an image displayed in a character input area of the LCD of the PDA of FIG. 1;

FIG. 4 is a perspective view showing an example of a configuration of the rear of the PDA of FIG. 1;

FIG. 5 is a block diagram showing an example of an internal configuration of the PDA of FIG. 1;

FIG. 6 is a block diagram showing an example of a particular configuration of a reader device shown in FIG. 5;

FIG. 7 is a block diagram showing an example of a configuration of a contactless IC card compatible with the reader device shown in FIG. 5;

FIG. 8 is a view illustrating specifications of the contactless IC card of FIG. 7;

FIG. 9 is a diagrammatic view illustrating an example of transition in mode when an IC card viewer A is executed in the PDA of FIG. 1;

FIG. 10 is a flow chart illustrating an example of an activation process executed by the PDA of FIG. 1;

FIG. 11 is showing an example of a configuration of an error screen displayed on the LCD unit of the PDA of FIG. 1;

FIGS. 12 and 13 are flow charts illustrating an example of a polling process executed by the PDA of FIG. 1;

FIG. 14 is a view showing an example of a configuration of an initial screen displayed on the LCD unit of the PDA of FIG. 1;

FIG. 15 is a similar view but showing another example of a configuration of the initial screen displayed on the PDA of FIG. 1;

FIG. 16 is a view showing an example of a configuration of a read error screen displayed on the LCD unit of the PDA of FIG. 1;

FIG. 17 is a view showing an example of a configuration of a card detection error screen displayed on the LCD unit of the PDA of FIG. 1;

FIGS. 18 and 19 are flow charts illustrating an example of a balance display process executed by the PDA of FIG. 1;

FIG. 20 is a view showing an example of a configuration of a balance display screen displayed on the LCD unit of the PDA of FIG. 1;

FIG. 21 is a similar view but showing another example of a configuration of the balance display screen displayed on the LCD unit of the PDA of FIG. 1;

FIG. 22 is a view showing an example of a configuration of a display end screen displayed on the LCD unit of the PDA of FIG. 1;

FIG. 23 is a view showing another example of a configuration of the display end screen displayed on the LCD unit of the PDA of FIG. 1;

FIGS. 24 and 25 are flow charts illustrating a history information display and storage process executed by the PDA of FIG. 1;

FIG. 26 is a view showing an example of a configuration of a history display screen displayed on the LCD unit of the PDA of FIG. 1;

FIG. 27 is a similar view but showing another example of a configuration of the history display screen displayed on the LCD unit of the PDA of FIG. 1;

FIG. 28 is a similar view but showing a still further example of a configuration of the history display screen displayed on the LCD unit of the PDA of FIG. 1;

FIG. 29 is a similar view but showing a yet further example of a configuration of the history display screen displayed on the LCD unit of the PDA of FIG. 1;

FIG. 30 is a view showing an example of a configuration of a history storage confirmation screen displayed on the LCD unit of the PDA of FIG. 1;

FIG. 31 is a diagrammatic view illustrating a manner of updating of database information by a storage section of the PDA of FIG. 1;

FIGS. 32 and 33 are flow charts illustrating a history deletion process executed by the PDA of FIG. 1;

FIG. 34 is a view showing an example of a configuration of a history deletion screen displayed on the LCD unit of the PDA of FIG. 1;

FIG. 35 is a view showing another example of a configuration of the history deletion screen displayed on the LCD unit of the PDA of FIG. 1;

FIG. 36 is a view showing an example of a configuration of a deletion error screen displayed on the LCD unit of the PDA of FIG. 1;

FIG. 37 is a view showing an example of a configuration of a deletion confirmation screen displayed on the LCD unit of the PDA of FIG. 1;

FIG. 38 is a view showing an example of a configuration of a deletion end confirmation screen displayed on the LCD unit of the PDA of FIG. 1;

FIG. 39 is a diagrammatic view illustrating an example of transition in mode when an IC card viewer B is executed by the PDA of FIG. 1;

FIG. 40 is a view showing a still further example of a configuration of the initial screen displayed on the LCD unit of the PDA of FIG. 1;

FIG. 41 is a view showing a yet further example of a configuration of the initial screen displayed on the LCD unit of the PDA of FIG. 1;

FIG. 42 is a view showing another example of a configuration of the read error screen displayed on the LCD of the PDA of FIG. 1;

FIG. 43 is a view showing another example of a configuration of the card detection error screen displayed on the LCD of the PDA of FIG. 1;

FIGS. 44 and 45 are flow charts illustrating another example of the balance display process executed by the PDA of FIG. 1;

FIG. 46 is a view showing a further example of a configuration of the balance display screen displayed on the LCD unit of the PDA of FIG. 1;

FIG. 47 is a view showing a still further example of a configuration of the balance display screen displayed on the LCD unit of the PDA of FIG. 1;

FIG. 48 is a view showing a further example of a configuration of the display end screen displayed on the LCD unit of the PDA of FIG. 1; and

FIG. 49 is a view showing a still further example of a configuration of the display end screen displayed on the LCD unit of the PDA of FIG. 1.

### DETAILED DESCRIPTION OF THE PREFERRED EMBODIMENT

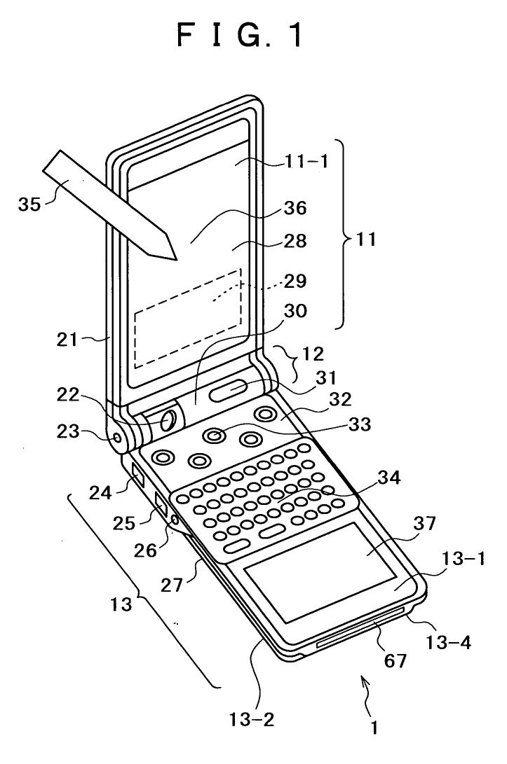

FIG. 1 shows an example of a configuration of a front elevational view of a PDA (Personal Digital Assistant) as an information processing apparatus to which the present invention is applied.

Referring to FIG. 1, the PDA 1 shown includes a display section 11 and a body section 13 connected for foldable pivotal movement to each other by and around a hinge section 12 provided at a central position thereof. In other words, the display section 11 can be pivoted in opening and closing movements from and to the body section 13 around an axis of the hinge section 12. Further, the display section 11 is supported for pivotal motion with respect to the body section 13 around an axis substantially perpendicular to the axis of the hinge section 12.

A LCD unit 28 is provided over an overall area of a face 11-1 of the display section 11, and a transparent touch panel 36 is layered on the surface of the LCD unit 28. If a touch pen 35 is placed at an arbitrary point on the LCD unit 28, then the coordinates at the position are detected by the touch panel 36, and a predetermined process corresponding to the detected coordinates is performed.

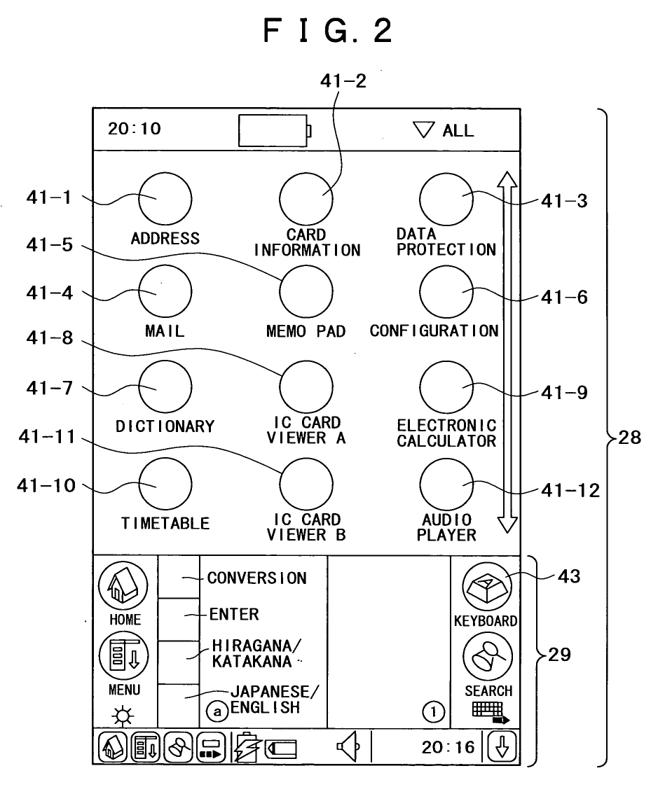

For example, if it is assumed that such an image as shown in FIG. 2 is displayed on the LCD unit 28, then if a user operates the touch pen 35 to depress one of software buttons 41-1 to 41-12 (places the touch pen 35 at a position on one of the software buttons 41-1 to 41-12), then application software allocated to the software button 41 is activated.

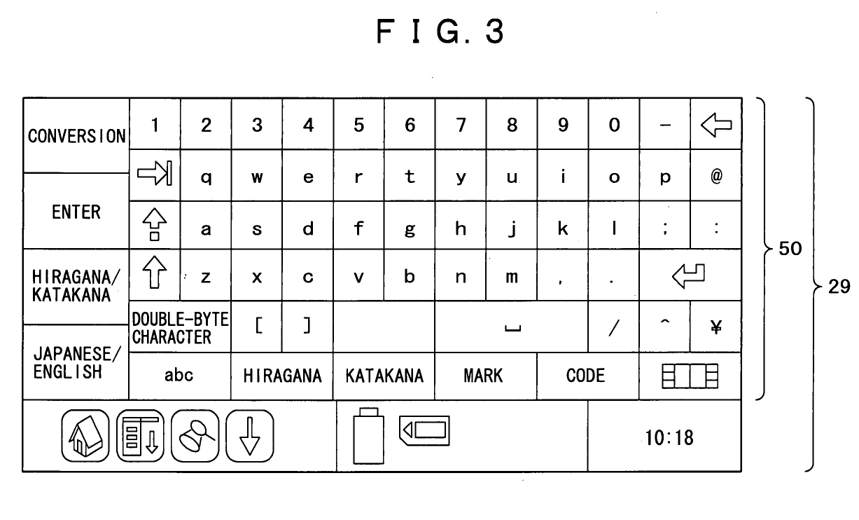

Further, if the user operates the touch pen 35 to depress a software button 43, then a software keyboard 50 shown in FIG. 3 is displayed in a character input area 29. If the user operates the touch pen 35 to depress an arbitrary one of keys on the software keyboard 50, then a character (or a mark or the like) corresponding to the depressed key is inputted. In particular, the coordinates at which the touch pen 35 is disposed is detected by the touch panel 36, and the key corresponding to the coordinates is recognized and a character (or a mark or the like) allocated to the recognized key is inputted.

In this manner, the user can utilize the touch pen 35 and the character input area 29 as software to input a character readily and rapidly. It is to be noted that, since the touch panel 36 is layered over the overall area of the display face of the LCD unit 28, the position of the character input area 29 with respect to the LCD unit 28 is not limited to that shown in FIG. 1. For example, if the image shown in FIG. 2 is reversed upwardly and downwardly and also leftwardly and rightwardly, then the character input area 29 is disposed at an upper position in FIG. 1 and is displayed reversely in the upward and downward directions. Also in such an instance, the user can input a character in a similar manner to that described above.

Referring back to FIG. 1, a power supply button 31 is provided rightwardly in FIG. 1 on the hinge section 12 and is used to turn on or off the power supply to the PDA 1. A light emitting diode (LED) 30 is provided on the left side of the power supply button 31 on the hinge section 12. The LED 30 is lit when a battery not shown built in the PDA 1 is being charged, but is turned off when the battery is charged up. A camera 22 in the form of a CCD (charge-coupled device) unit or a CMOS (Complementary Metal Oxide Semiconductor) sensor unit is provided for pivotal motion on the left side of the LED 30 on the hinge section 12. A capture button 23 is provided at the left end of the hinge section 12 and is operated to pick up an image pickup subject by means of the camera 22.

When the user tries to pick up an image of an image pickup subject, the user will depress the capture button 23 once to activate application software having a camera function (a function of picking up an image of an image pickup subject by means of the camera 22 and recording the picked up image of the image pickup subject) to pivot the camera 22 so that the image pickup direction of the camera 22 may be directed to the image pickup subject. At this time, an image picked up by the camera 22, that is, an image of the image pickup subject, is displayed on the LCD unit 28 as hereinafter described. Therefore, the user will confirm the LCD unit 28 to decide the position of the camera 22 and depress the capture button 23 which functions as a shutter button once again. Consequently, an image picked up by the camera 22 at the point of time when the capture button 23 is depressed is stored into the memory of the PDA 1.

Buttons 32 are provided on a face 13-1 of the body section 13 which opposes to the display section 11 when the body section 13 is folded, and symbols representative of different kinds of application software installed in the PDA 1 are printed individually on the buttons 32. If the user depresses one of the buttons 32, then the corresponding application software is activated. In particular, the buttons 32 are buttons as hardware corresponding to some of the software buttons 41-1 to 41-12 of FIG. 2 described hereinabove.

A scroll button 33 is provided at a central portion of a region of the face 13-1 in which the buttons 32 are disposed and is used to scroll an image displayed on the LCD unit 28.

A keyboard 34 for inputting characters including marks and so forth is provided at a portion of the face 13-1 below the buttons 32. The keyboard 34 is a keyboard as hardware corresponding to the software keyboard 50 described hereinabove with reference to FIG. 3.

A reader device 37 is built in the body section 13 below the keyboard 34 and is used to perform short distance radio communication with an IC card to read out information recorded in the IC card. In particular, the reader device 37 detects an IC card positioned in the proximity of the face 13-1 and communicates by radio with the IC card.

A remote controller and a headphone jack 24 are provided at upper positions in FIG. 1 of a face 13-2 (side face) of the body section 13 perpendicular to the face 13-1. The headphone jack 24 is connected to an external headphone and outputs sound to the headphone or the like. A jog dial 25 is provided at a position of the face 13-2 of the body section 13 below the headphone jack 24 such that it can be depressed and rotated and projects a little from the face 13-2. A back button 26 for canceling an immediately preceding operation is provided below the jog dial 25. Further, a hold switch 27 is provided below the back button 26 for inhibiting, when some other button is depressed in error, execution of a function corresponding to the button.

A connector 67 is provided at a central portion of a face 13-4 of the body section 13 perpendicular to the faces 13-1 and 13-2, that is, an end face of the body section 13 on the lower side in FIG. 1 and is used to connect an attachment apparatus such as a cradle thereto.

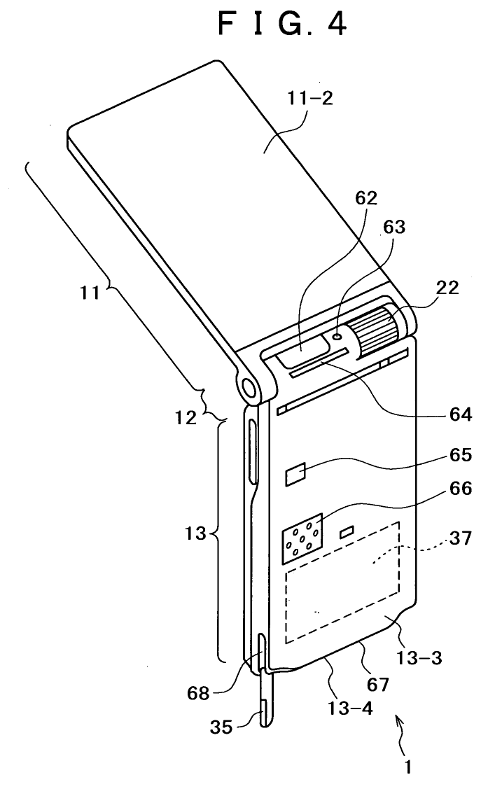

FIG. 4 shows an example of a configuration of the rear face of the PDA 1. Referring to FIG. 4, a slot 64, a lamp 63 and an infrared port 62 are provided at upper portions of the left side of the hinge section 12 in FIG. 4. The slot 64 is adapted to removably receive a memory card 143 or a function expanding module 121 having an interface similar to that of the memory card 143. The memory card 143 includes a flash memory device which is a nonvolatile memory which allows electrical rewriting and erasure and is a kind of an EEPROM (Electrically Erasable and Programmable Read Only Memory), and a plastic case of a small thickness and a small size in which the flash memory device is accommodated. The lamp 63 is lit when data is read out from or written into the memory card 143. The infrared port 62 is used for communication with some other apparatus using infrared rays.

The memory card 143 is controlled by a controller for the flash memory device provided in the slot 64 or the memory card 143. Thus, various kinds of information (data) such as an image, sound and music supplied through the slot 64 can be written into the memory card 143, and various kinds of stored information can be read out from the memory card 143. Since such a memory card 143 as described above can be loaded into the PDA 1, the PDA 1 can share data with another apparatus through the memory card 143.

A reset button 65 for resetting the PDA 1 is provided on the left side in FIG. 4 at a central portion of a face 13-3 of the body section 13 opposite to the face 13-1. A speaker 66 for outputting sound is provided below the reset button 65 on the face 13-3 of the body section 13.

The connector 67 is provided at a central portion of the face 13-4 (end face on the lower side in FIG. 4) perpendicular to the faces 13-1 and 13-3 of the body section 13 as described above, and an accommodation opening 68 for accommodating a touch pen 35 is provided leftwardly of the connector 67 in FIG. 4.

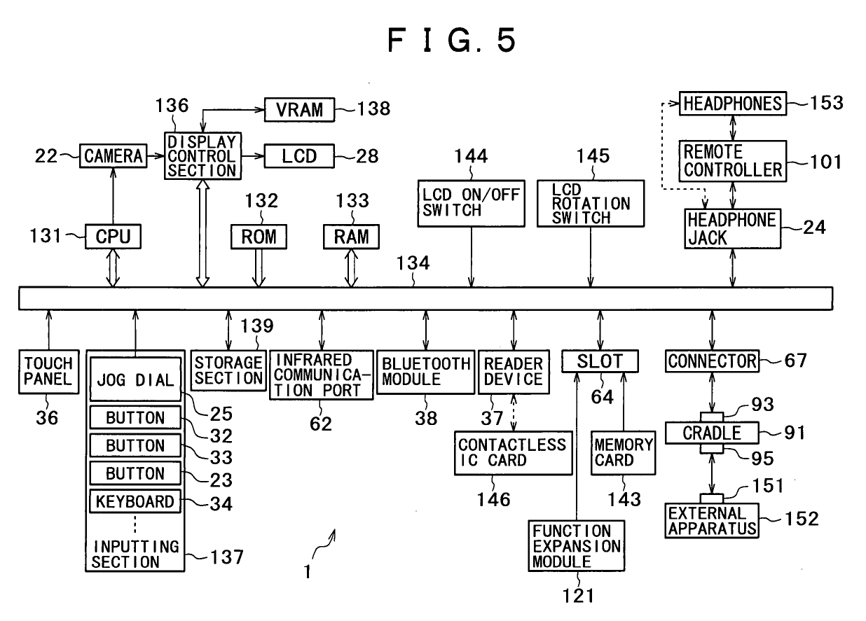

FIG. 5 shows an example of an internal configuration of the PDA 1.

Referring to FIG. 5, a CPU (Central Processing Unit) 131 executes various processes in accordance with a program stored in a ROM (Read Only Memory) 132 or a program loaded into a RAM (Random Access Memory) 133 from a storage section 139. Also data necessary for the CPU 131 to execute various processes is stored suitably into the RAM 133.

The CPU 131, ROM 132 and RAM 133 are connected to each other by a bus 134. Also a display control section 136 for controlling the LCD unit 28 to display an image is connected to the bus 134.

The display control section 136 is controlled by the CPU 131, and the camera 22 and the LCD unit 28 described hereinabove as well as a VRAM (Video RAM) 138 are connected to the display control section 136. The display control section 136 stores an image picked up by the camera 22 into the VRAM 138 and causes the LCD unit 28 to display an image stored in the VRAM 138 or an image stored in another memory, for example, the RAM 133, storage section 139 or a memory card 143 connected to the slot 64.

Further, an inputting section 137 including the keyboard 34, buttons 22, 32 and 33, jog dial 25 and so forth described hereinabove, the touch panel 36, the infrared port 62, and the slot 64 into which a memory card 143 or a function expanding module 121 is loaded are connected to the bus 134. Furthermore, the connector 67 and the headphone jack 24 as well as a Bluetooth module 38 and the reader device 37 are connected to the bus 134. To the connector 67, a cradle 91 and so forth are connected. The cradle 91 is used to charge a battery not shown built in the PDA 1 and serving as a repeating apparatus for communication with some other external apparatus 152. The headphone jack 24 serves as a sound outputting section adapted to be connected to the remote controller 101 or a headphone 153. The Bluetooth module 38 performs radio communication using the Bluetooth with another communication apparatus. The reader device 37 performs short distance radio communication with an IC card 146 positioned nearly thereto.

It is to be noted that coordinates detected by the touch panel 36 are provided to the CPU 131 through the bus 134, and the CPU 131 acquires predetermined information corresponding to the coordinates provided thereto.

Further, as occasion demands, the storage section 139 formed from a hard disk or the like is connected to the bus 134. A computer program read out from a magnetic disk, an optical disk, a magneto-optical disk, a semiconductor memory or a like element loaded suitably into the external apparatus 152 is supplied to the PDA 1 and install into the storage section 139 as occasion demands. In this instance, such means as radio communication through the infrared port 62, Bluetooth module 38 or reader device 37, radio communication through a wireless LAN module (function expansion module) 121 or wire communication through the cradle 91 is used. Also a computer program read out from a memory card 143 loaded suitably into the slot 64 is installed into the storage section 139 as occasion demands.

In addition, an LCD on/off switch 144 and an LCD rotation switch 145 are connected to the bus 134. The LCD on/off switch 144 exhibits an on state when the display section 11 is in a closed state with respect to the body section 13, but exhibits an off state when the display section 11 is in an open state with respect to the body section 13. The LCD rotation switch 145 exhibits an on state when the display section 11 is pivoted by more than a predetermined pivotal angle.

In short, in the example shown in FIG. 5, the CPU 131 recognizes an open or closed sate (hereinafter referred to as LCD open/closed state) and a pivoted state of the display section 11 with respect to the body section 13 and a pivoted state of the camera 22 based on on or off states of the LCD on/off switch 144 and LCD rotation switch 145.

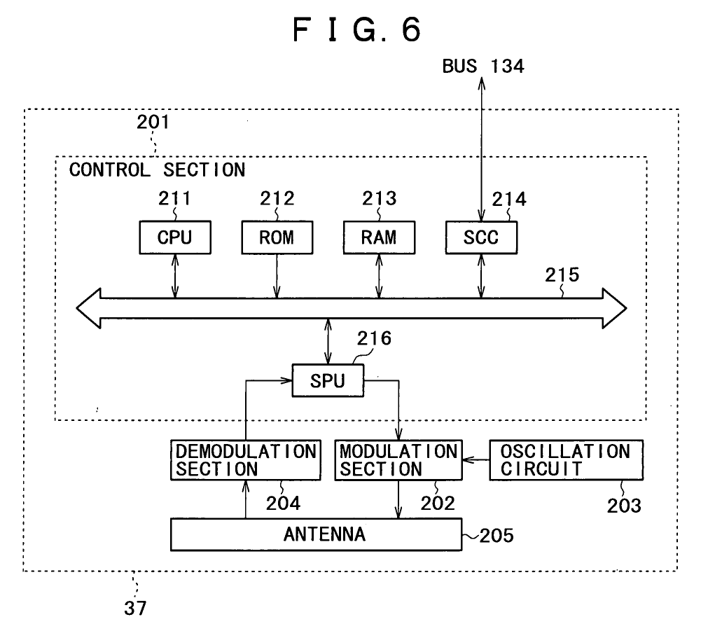

FIG. 6 shows an example of a particular configuration of the reader device 37 shown in FIG. 5.

Referring to FIG. 6, an IC 201 includes a CPU 211, a ROM 212, a RAM 213, a serial communication controller (SCC) 214, a signal processing unit (SPU) 216, and a bus 215 for interconnecting the elements 211 to 216.

The CPU 211 expands a control program stored in the ROM 212 into the RAM 213 and executes various processes in accordance with, for example, response data transmitted thereto from a contactless IC card 146 or a control signal supplied thereto from the CPU 131 of FIG. 5. For example, the CPU 211 produces a command to be transmitted to the contactless IC card 146 and outputs the command to the SPU 216 through the bus 215, or performs an authentication process of data transmitted thereto from the contactless IC card 146.

The SCC 214 supplies data transmitted thereto from the CPU 131 of FIG. 5 to the CPU 211 or outputs data supplied thereto from the CPU 211 through the bus 215 to the CPU 131.

The SPU 216 performs, when response data from the contactless IC card 146 is supplied thereto from a demodulation section 204, such a process, for example, as BPSK (Binary Phase Shift Keying) demodulation (decoding of a Manchester code) for the data and supplies the acquired data to the CPU 211. Further, the SPU 216 performs, when a command to be transmitted to the contactless IC card 146 through the bus 215 is supplied thereto, BPSK modulation (coding into a Manchester code) for the command and outputs the acquired data to a modulation section 202.

The modulation section 202 ASK (Amplitude Shift Keying) modulates a carrier of a predetermined frequency (for example, 13.56 MHz) supplied thereto from an oscillation circuit (OSC) 203 with data supplied thereto from the SPU 216 and outputs the produced modulation wave as an electromagnetic wave from an antenna 205. Meanwhile, the demodulation section 204 demodulates a modulation wave (ASK modulation wave) acquired through the antenna 205 and outputs the demodulated data to the SPU 216.

The antenna 205 radiates a predetermined electromagnetic wave, and it is detected based on a variation of the load caused by the electromagnetic wave whether or not a contactless IC card 146 is positioned nearly to the antenna 205. Then, for example, when a contactless IC card 146 is positioned nearly to the antenna 205, the antenna 205 transmits and receives various data to and from the contactless IC card 146.

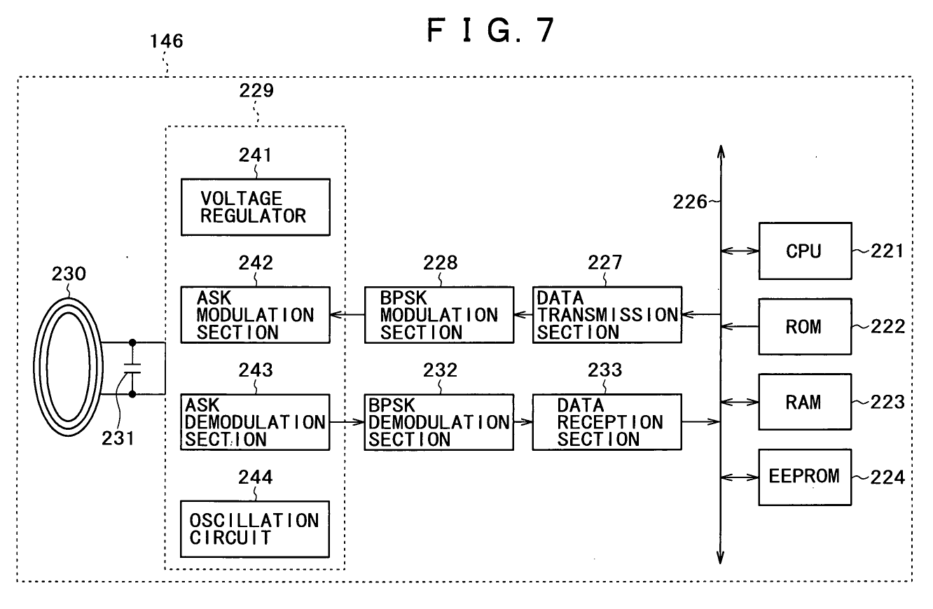

FIG. 7 shows an example of a particular configuration of the contactless IC card 146.

The contactless IC card 146 is formed from an IC wherein, for example, an antenna (loop antenna) 230 and a capacitor 231 shown in FIG. 7 and other necessary components are accommodated in one chip. The contactless IC card 146 performs half-duplex operation of various data to and from the reader device 37 and so forth provided in the PDA 1 making use of the electromagnetic induction, but is not necessarily be formed as a card. Further, the term “IC card” is a name used for the convenience of description and is intended to have such functions as described hereinabove and as hereinafter described. For example, a Felica chip (registered trademark) is available as a device which provides basically similar functions to those of the contactless IC card 146.

A CPU 221 expands a control program stored in a ROM 222 into a RAM 223 and controls operation of the entire contactless IC card 146. For example, when an electromagnetic wave radiated from the reader device 37 provided on the PDA 1 or the like is received by an antenna 230, the CPU 221 notifies the reader device 37 of IC card information including a card identification number and so forth set to the contactless IC card 146 in response to the received electromagnetic wave. Further, the CPU 221 supplies history information of commercial transactions to the reader device 37 in response to a request from the reader device 37.

An LC circuit formed from the antenna 230 and the capacitor 231 resonates with an electromagnetic wave of a predetermined frequency radiated from the reader device 37 or the like provided on the PDA 1 and disposed in the proximity thereof. An interface section 229 includes an ASK demodulation section 243 which envelope detects a modulation wave (ASK modulation wave) received through the antenna 230 to demodulate the modulation wave and outputs the demodulation data to a BPSK demodulation (Binary Phase Shift Keying) section 232.

Further, in the interface section 229, an ac magnetic field excited by the antenna 230 is rectified by an ASK demodulation section 243 and stabilized by a voltage regulator 241 so as to be supplied as a dc power supply to the components. Power of the electromagnetic wave to be radiated from the reader device 37 or the like is adjusted so as to generate a magnetic field which supplies necessary power to the contactless IC card 146 as hereinafter described.

An oscillation circuit 244 of the interface section 229 includes a built-in PLL (Phase Locked Loop) circuit and generates a clock signal of a frequency equal to the clock frequency of a reception signal.

Further, for example, when a request for balance information or the like is to be transmitted to the reader device 37 or the like provided on the PDA 1, the interface section 229 controls, for example, a predetermined switching element (not shown) to be switched on/off in response to data supplied thereto from the BPSK modulation section 228. For example, only when the switching element is on, a predetermined load is connected in parallel to the antenna 230 to vary the load of the antenna 230.

An ASK modulation section 242 ASK modulates a BPSK modulation wave supplied thereto from a BPSK modulation section 228 in response to a variation of the load of the antenna 230 and transmits a modulation component to the reader device 37 through the antenna 230 (to vary the terminal voltage of the antenna of the reader device 37) (load switching system).

When the data demodulated by the ASK demodulation section 243 is BPSK modulation data, the BPSK demodulation section 232 performs demodulation (decoding of a Manchester code) of the data based on a clock signal supplied thereto from the PLL circuit not shown and outputs the demodulated data to a data reception section 233. The data reception section 233 suitably outputs the data supplied thereto to the CPU 221. The CPU 221 stores the data into the RAM 223 or an EEPROM 224.

Data stored in the EEPROM 224 is read out by the CPU 221 and supplied to a data transmission section 227. The BPSK modulation section 228 performs BPSK modulation (coding into a Manchester code) for the data supplied thereto from the data transmission section 227 and outputs resulting data to the ASK modulation section 242.

Electronic money information is stored into the EEPROM 224. The user can make use of the electronic money to settle the price for a purchased commodity, service or the like. Also a history of settlements is stored into the EEPROM 224.

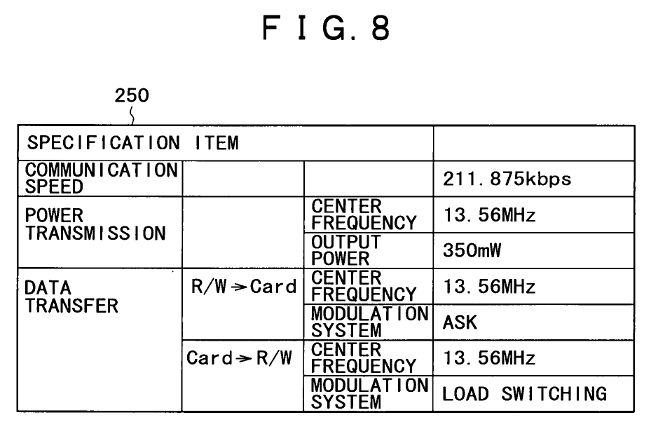

FIG. 8 illustrates an example of specifications of the contactless IC card 146.

As described hereinabove, the communication between the reader device 37 and the contactless IC card 146 is performed by half-duplex operation, and the communication speed typically is 211.875 kbps.

As seen from FIG. 8, the center frequency of a frequency band used for power transmission and data transmission from the reader device 37 to the contactless IC card 146 and data transmission from the contactless IC card 146 to the reader device 37 typically is 13.56 MHz.

The output power of an electromagnetic wave outputted from the reader device 37 for power transmission typically is 350 mW, and the communication distance typically is approximately 10 cm although it depends upon the communication environment such as a characteristic of the antenna.

Data to be transferred from the reader device 37 to the contactless IC card 146 is obtained by ASK modulation of data coded in a Manchester code as described hereinabove, and the modulation degree of the data, that is, the maximum amplitude of the data signal/maximum amplitude of the carrier, typically is 0.1. Meanwhile, data to be transferred from the contactless IC card 146 to the reader device 37 is obtained by conversion of output data into a transmission signal in accordance with the load switching system, that is, by variation of the load of the antenna 230 through switching on/off of the switching element in response to the output data.

The user of the PDA 1 having such a configuration as described above will use the functions of the reader device 37 described hereinabove to cause the LCD unit 28 of the PDA 1 to display history information of commercial transactions (settlements) stored in a contactless IC card 146, balance information of the electronic money stored or charged in the contactless IC card 146 or like information.

In particular, if the user operates the PDA 1 to activate an application for performing the process described hereinabove and operates a contactless IC card 146 to move to the position near to the reader device 37 on the face 13-1 of the PDA 1, then the CPU 131 of the PDA 1 controls the reader device 37 to read history information and other information from the contactless IC card 146 and controls the LCD unit 28 to display the read information.

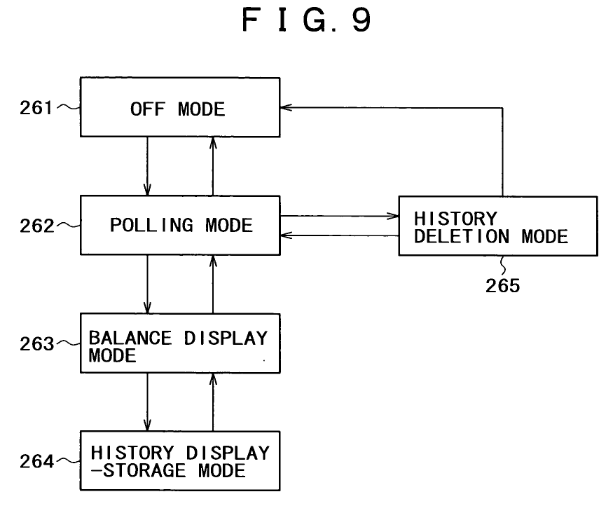

When the CPU 131 executes the application, it exhibits a transition among a plurality of modes as seen in FIG. 9 and executes, in each of the modes, a process prescribed for the mode.

In particular, referring to FIG. 9, when the CPU 131 executes the application, it enters into a polling mode 262 from an off mode 261 in which the application is not executed. In the polling mode 262, the CPU 131 controls the reader device 37 to perform a process of detecting a contactless IC card 146 positioned near to the reader device 37.

In the off mode 261, the power supply to the reader device 37 is off, and the PDA 1 does not perform such a process as a process of communicating with the contactless IC card 146 or displaying the history information on the LCD unit 28.

If, when the CPU 131 is in the off mode 261, the user operates the touch pen 35 to depress the software button 41-8 of an “IC card viewer A” on such a GUI as shown in FIG. 2 displayed on the LCD unit 28, then the inputting section 137 supplies the information to the CPU 131 through the bus 134. In response to the operation, the CPU 131 reads out an application stored in the storage section 139 or the like and corresponding to the operation and executes the application.

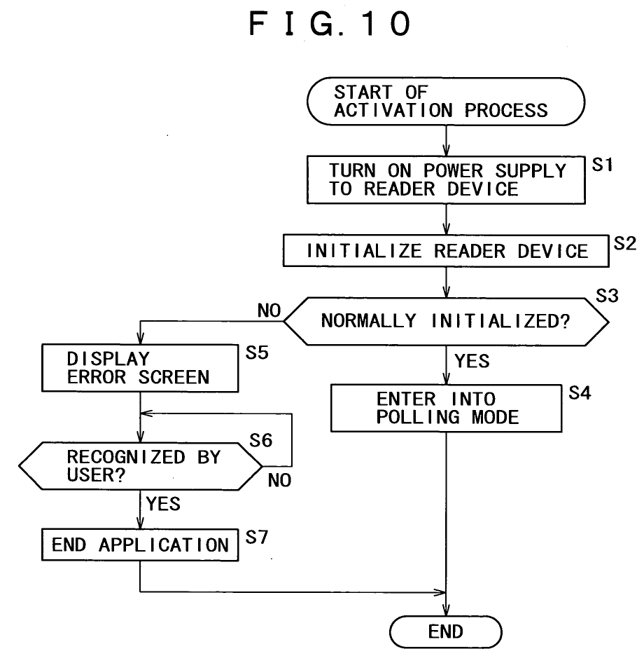

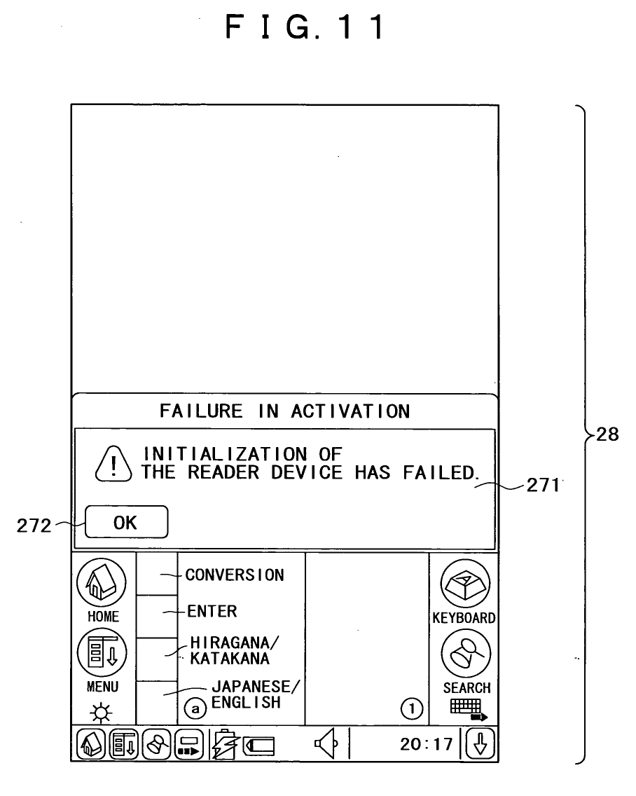

An activation process executed thereupon by the CPU 131 is described with reference to a flow chart of FIG. 10. Also FIG. 11 is referred to as occasion demands.

First at step S1, the CPU 131 controls the reader device 37 to switch on the power supply to the reader device 37. At step S2, the CPU 131 executes an initialization process for the reader device 37.

After the initialization process comes to an end, the CPU 131 discriminates at step S3 whether or not the initialization is completed normally. If it is discriminated that the initialization process is completed normally, then the CPU 131 changes, at step S4, the current mode into the polling mode in which detection of a contactless IC card is to be performed, and then ends the activation process.

On the other hand, if it is discriminated at step S3 that the initialization process is not completed normally, then the CPU 131 advances the processing to step S5, at which the CPU 131 controls the LCD unit 28 to display such an error screen 271 as shown in FIG. 11 so that the user may confirm that the initialization is not completed normally.

Referring to FIG. 11, a message “Initialization of the reader device has failed” and an OK button 272 are displayed on the error screen 271 displayed on the LCD unit 28. The user will operate the touch pen 35 to depress the OK button 272, that is, tap the OK button 272 using the touch pen 35, to confirm that the initialization results in failure.

Referring back to FIG. 10, the CPU 131 discriminates at step S6 whether or not the failure in initialization is confirmed by the user, that is, whether or not the user depresses the OK button 272. The CPU 131 stands by until after it discriminates that the failure in initialization is confirmed.

Then, if it is discriminated that the failure in initialization is confirmed by the user, then the CPU 131 erases, at step S7, the error screen 271 and ends the application, that is, the IC card viewer A, while it keeps the off mode, and then ends the activation process.

In short, upon activation of the application (IC card viewer A), the CPU 131 executes an initialization process for the reader device 37, and then when the initialization process is completed normally, the CPU 131 enters the polling mode. However, if the initialization process results in failure, then the CPU 131 causes an error screen to be displayed and ends the application, that is, the IC card viewer A.

The CPU 131 of the PDA 1 after it enters into the polling mode 262 from the off mode 261 of FIG. 9 as a result of execution of such an activation process as described above now performs a process of detecting a nearly positioned contactless IC card 146.

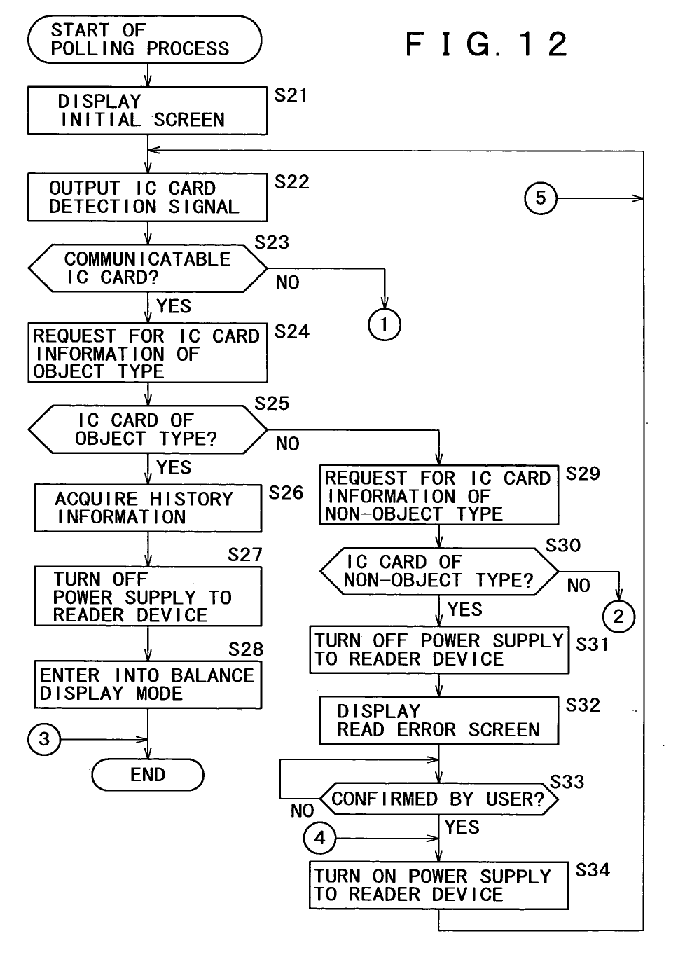

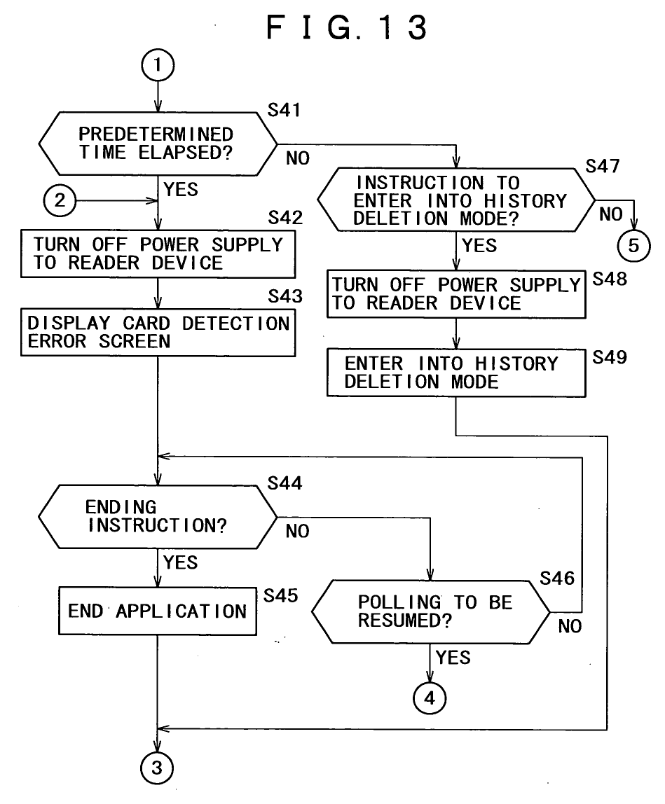

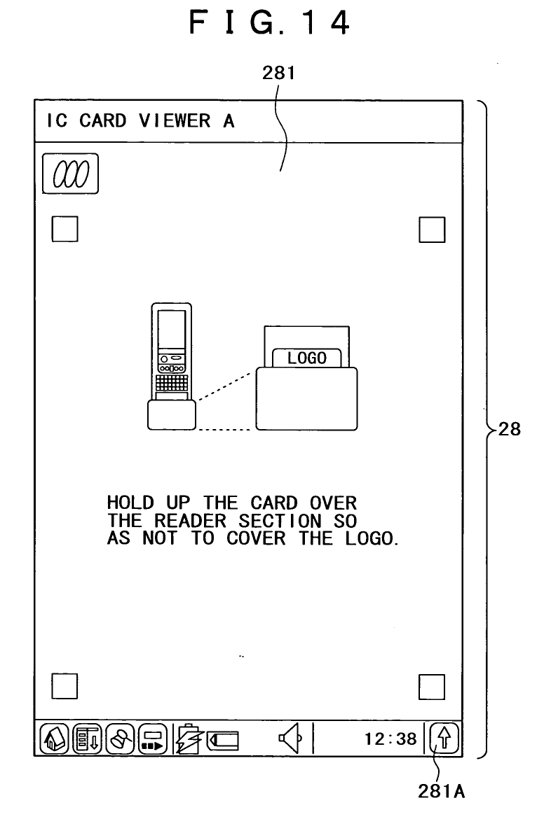

A polling process executed in the polling mode 262 is described below with reference to flow charts of FIGS. 12 and 13. Also FIGS. 14 to 16 are referred to as occasion demands.

First at step S21, the CPU 131 controls the display control section 136 to display such an initial screen 281 as shown in FIG. 14 on the LCD unit 28.

Referring to FIG. 14, the initial screen 281 displays a message “Hold up the card over the reader section so as not to cover the logo”. The user will operate a contactless IC card 146 so as to be positioned near to the reader device 37 in accordance with the message.

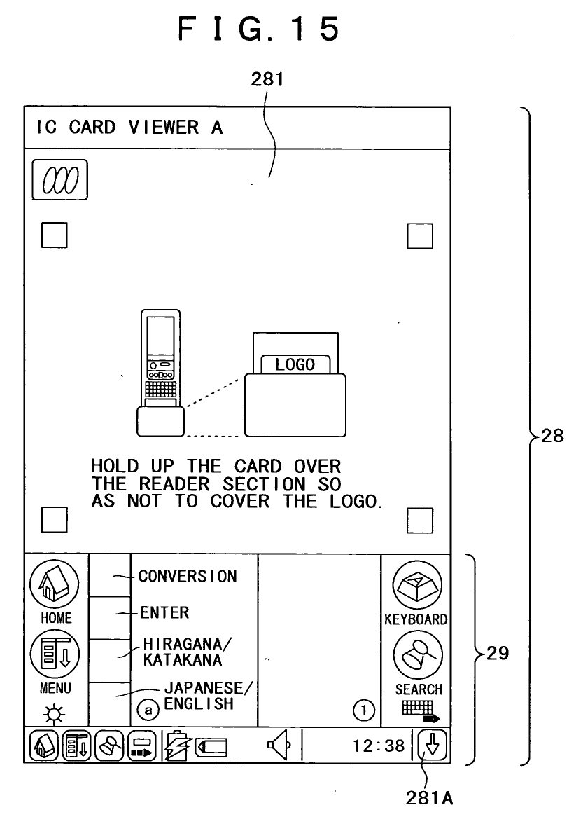

It is to be noted that a display changeover button 281A having an upwardly directed arrow mark thereon is displayed on the right side of a lower portion of the initial screen 281. If the user depresses the display changeover button 281A, that is, if the user uses the touch pen 35 to tap at the display changeover button 281A, then the initial screen 281 and the character input area 29 are displayed simultaneously on the LCD unit 28 as seen in FIG. 15.

Referring to FIG. 15, a downwardly directed arrow mark is displayed on the display changeover button 281A. If the user depresses the display changeover button 281A, then the CPU 131 controls the display control section 136 to display the initial screen 281 in such a state as seen in FIG. 14 on the LCD unit 28.

Referring back to FIG. 12, the CPU 131 having caused such an initial screen 281 as described above to be displayed now controls, at step S22, the reader device 37 to output an IC card detection signal toward the contactless IC card 146 positioned in the proximity of the reader device 37 of the face 13-1.

The IC card detection signal is based on a protocol determined in advance for communication to be performed between the contactless IC card 146 and the reader device 37. If the contactless IC card 146 positioned near to the reader device 37 is compatible with the reader device 37, then it receives and responds to the card detection signal. The reader device 37 detects in response to the response that the contactless IC card 146 is positioned near to it.

Accordingly, in case a card other than the contactless IC card 146 or a contactless IC card which is not compatible with the communication protocol, for example, an IC card produced by a different company and having a different communication protocol is positioned near to the reader device 37, the reader device 37 discriminates that the contactless IC card 146 is not positioned near to it because those cards do not respond to the IC card detection signal outputted from the reader device 37.

At step S23, the CPU 131 discriminates whether or not a communicatable contactless IC card 146 is present within the communication range. If it is discriminated that a communicatable contactless IC card 146 is present within the communication range, then the CPU 131 advances the processing to step S24, at which it supplies an encryption key (decryption key) corresponding to the type of the IC card of an object of the application and issues a request for IC card information.

Various kinds are available for the contactless IC card 146 depending upon the application or the enterprise administrating such contactless IC cards. For example, a contactless IC card administrated by an enterprise for the traffic and used for payment of the transportation charge of the traffic, another contactless IC card used for the commercial transactions in particular affiliated shops or on the Internet, and a further contactless IC card administrated by a telephone company and used for the payment of the telephone charge when a public telephone is used are available.

Each of such cards is customized so as to be optimum for the individual method of use, and also information stored in the cards is different from each other and is not unified. In particular, usually such contactless IC cards store information after encrypted for the safety, and also the encryption key (decryption key) used for the encryption process and the decryption process is different depending upon the type of the card. Further, the contactless IC cards sometimes store part or all of information stored in the form of a plaintext without being encrypted. In this instance, also the contents of information stored without being encrypted differ among different types of cards.

Accordingly, the CPU 131 supplies, at step S24, an encryption key (decryption key) of the object type of the application (IC card viewer A) to the nearly positioned contactless IC card 146 to issue a request for IC card information which is information regarding the contactless IC card 146 and including an ID number allocated to the individual contactless IC card and other necessary information.

The contactless IC card 146 receives the request for IC card information and uses, if it is of the type compatible with the application, the encryption key (decryption key) supplied thereto from the reader device 37 to decrypt the IC card information thereof stored in an encrypted form therein. Then, the contactless IC card 146 supplies the decrypted IC card information to the reader device 37.

If the contactless IC card 146 positioned nearly to the reader device 37 is of a type which is not compatible with the application, it cannot use the encryption key (decryption key) acquired from the reader device 37 to decrypt the IC card information stored in an encrypted form therein. Therefore, the contactless IC card 146 cannot respond to the request for IC card information from the reader device 37 or performs an error response.

In response to such a response from the contactless IC card 146 as described above or to presence or absence of a response, the CPU 131 discriminates at step S25 of FIG. 12 whether or not the nearly positioned contactless IC card 146 is a card of the type which makes an object of the application. If the CPU 131 discriminates based on the IC card information supplied from the contactless IC card 146 and acquired by the reader device 37 that the contactless IC card 146 is of the type of the object, it advances the processing to step S26. At step S26, the CPU 131 controls the reader device 37 to acquire history information regarding a history of settlements, a balance of the electronic money and so forth from the contactless IC card 146.

Then at step S27, the CPU 131 switches off the power supply to the reader device 37 having completed the communication process. Then at step S28, the CPU 131 changes over the mode thereof from the polling mode 262 at present to a balance display mode 263 and ends the polling process.

If it is discriminated at step S25 that the nearly positioned contactless IC card 146 is an IC card of a type which does not make an object of the application because a response to the request for IC card information is not received from the nearly positioned contactless IC card 146 or an error response is received, then the CPU 131 advances the processing to step S29. At step S29, the CPU 131 supplies an encryption key (decryption key) for another type which does not make an object in a similar manner as at step S24 to issue a request for IC card information of the incompatible type. It is to be noted that, if a request for IC card information of a plurality of card types is issued, then the process at step S29 is repeated for the different types.

If it is discriminated, at step S30, based on the response to the process described above from the contactless IC card 146 that the contactless IC card 146 is of a type which does not make an object, then the CPU 131 advances the processing to step S31, at which it switches off the power supply to the reader device 37 having ended the communication process.

It is to be noted that the discrimination process for an IC card of a type which does not make an object of the application may not be performed. In this instance, when it is discriminated at step S25 that the contactless IC card 146 is an IC card of a type which does not make an object of the application, the CPU 131 omits the processes at steps S29 and S30 and advances the processing immediately to step S31 so that the power supply to the reader device 37 having ended the communication process is switched off.

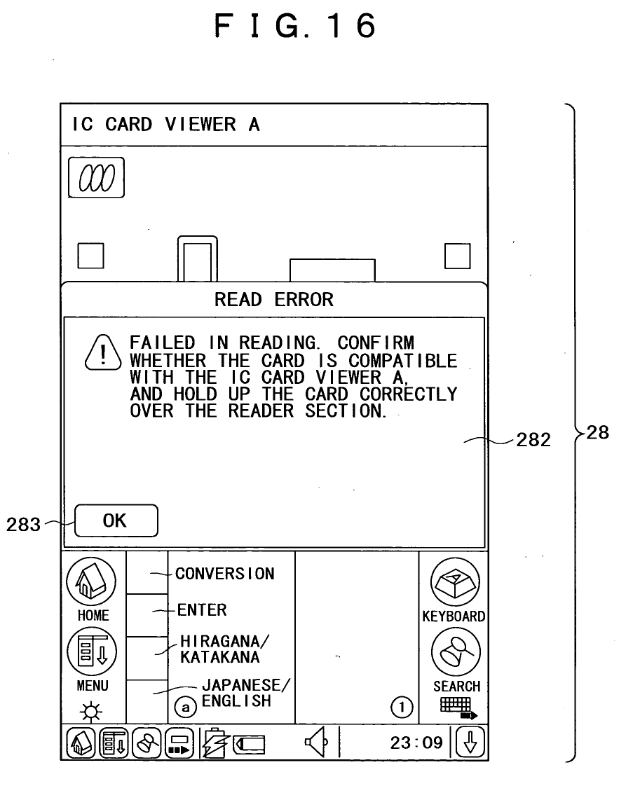

The CPU 131 having ended the process at step S31′ controls the LCD unit 28 to display such a read error screen as shown in FIG. 16 at step S32.

Referring to FIG. 16, the LCD unit 28 displays the read error screen 282. The read error screen 282 displays a message “Failed in reading. Confirm whether the card is compatible with the IC card viewer A, and hold up the card correctly over the reader section” and an OK button 283 to be depressed after confirmation by the user.

Referring back to FIG. 12, the CPU 131 controls the touch panel 36 to discriminate whether or not the user depresses the OK button 283 at step S33 and then stands by until after it is discriminated that the OK button 283 is depressed.

If it is discriminated that the user depresses the OK button 283 confirming the read error, then the CPU 131 switches on the power supply to the reader device 37 at step S34 and then returns the processing to step S22 so that the processes at the steps beginning with step S22 are repetitively executed.

If it is discriminated at step S23 that no communicatable IC card is present, then the CPU 131 advances the processing to step S41 of FIG. 13, at which it discriminates whether or not a predetermined period of time elapses.

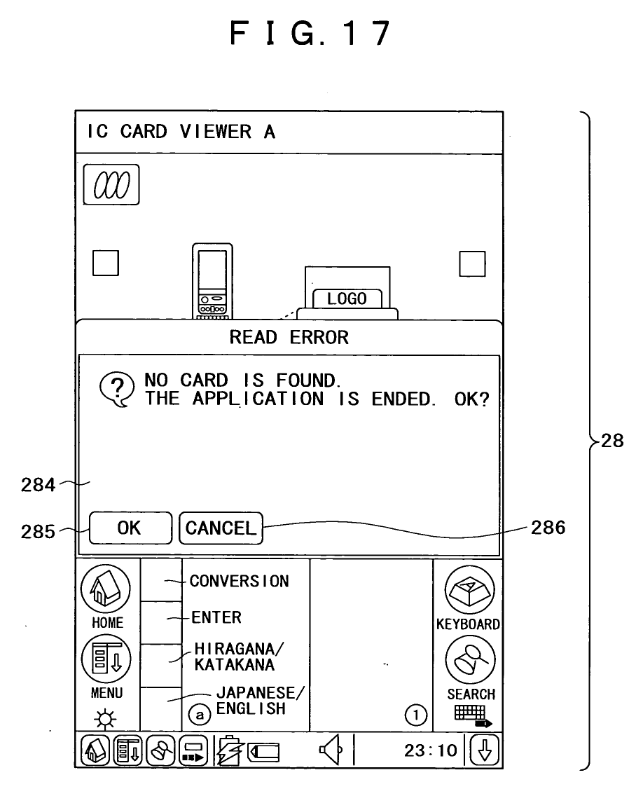

If it is discriminated that the predetermined period of time elapses, then the CPU 131 advances the processing to step S42, at which it switches off the power supply to the reader device 37. Then at step S43, the CPU 131 controls the LCD unit 28 to display such a card detection error screen as shown in FIG. 17.

Referring to FIG. 17, the LCD unit 28 displays the card detection error screen 284. The card detection error screen 284 includes a display of a message “No card is found. The application is ended. OK?”, and an OK button 285 and a cancel button 286. The OK button 285 is depressed by the user when the user tries to end the application, that is, the IC card viewer A. The cancel button 286 is depressed by the user when the user tries to cancel such ending of the application.

Referring back to FIG. 13, at step S44, the CPU 131 controls the touch panel 36 to discriminate whether or not the user depresses the OK button 285 to issue an instruction to end the application. If it is discriminated that an instruction to end the application is issued, then the CPU 131 ends the application at step S45 and places itself into the off mode 261 and then ends the polling process.

On the other hand, if it is discriminated at step S44 that an instruction to end the application is not issued because the user does not depress the OK button 285, then the CPU 131 advances the processing to step S46. At step S26, the CPU 131 discriminates whether or not the user depresses the cancel button 286 to cancel the ending of the application and issues an instruction to resume the polling. If it is discriminated that the user does not depress the cancel button 286 and therefore does not issue an instruction to resume the polling, then the processing returns the processing to step S44 so that the processes at the steps beginning with step S44 are repetitively executed. Then, if it is discriminated at step S46 that the user depresses the cancel button 286 to resume the polling, then the CPU 131 returns the processing to step S34 of FIG. 12 so that the processes at the steps beginning with step S34 are repetitively executed.

In particular, the CPU 131 stands by until the user operates the OK button 285 or the cancel button 286 on the card detection error screen 284 of FIG. 17. Then, if the OK button 285 or the cancel button 286 is depressed, then the CPU 131 executes a process based on an instruction corresponding to the depressed button.

It is to be noted that, if the CPU 131 discriminates at step S30 of FIG. 12 that the contactless IC card 146 positioned near to the reader device 37 is not of a type which does not make an object of the application, then it advances the processing to step S42 of FIG. 13 so that the processes at the steps beginning with step S42 are repetitively executed.

If it is discriminated at step S41 that the predetermined period of time does not elapse as yet, then the CPU 131 advances the processing to step S47. At step S47, the CPU 131 discriminates based on the instruction of the user whether or not an instruction to enter into a history deletion mode 265 of FIG. 9 is issued.

If it is discriminated that the user operates the PDA 1 to issue an instruction to enter into the history deletion mode 265, then the CPU 131 advances the processing to step S48, at which it switches off the power supply to the reader device 37. Then at step S49, the CPU 131 enters into the history deletion mode 265 and then ends the polling process. The history deletion mode 265 is hereinafter described.

If it is discriminated at step S47 that an instruction to enter into the history deletion mode is not issued, then the CPU 131 returns the processing to step S22 of FIG. 12 so that the processes at the steps beginning with step S22 are repetitively executed.

In particular, the CPU 131 waits until a communicatable IC card is detected while outputting an IC card detection signal in the polling process. If a communicatable IC card is not detected for a predetermined period of time, then the CPU 131 controls the LCD unit 28 to display the card detection error screen 284 and accepts an instruction of the user.

If, in this state, that is, when no contactless IC card 146 is positioned near to the reader device 37, the user issues an instruction to enter into the history deletion mode, then the CPU 131 enters into the history deletion mode.

On the other hand, if a communicatable IC card is detected, then the CPU 131 discriminates the type of the IC card. If the IC card is of a type compatible with the application, then the CPU 131 acquires history information from the contactless IC card 146 and then enters into the balance display mode 263.

If it is discriminated that the nearly positioned contactless IC card 146 is not compatible with the application, then the CPU 131 controls the LCD unit 28 to display the read error screen 282 and accepts an instruction of the user.

In particular, the CPU 131 executes a process suitable for the type of the IC card such as to control the LCD unit 28 to display a screen which differs depending upon the type of the contactless IC card 146 detected by the reader device 37. Consequently, if an error occurs, then the CPU 131 can control the LCD unit 28 to display a cause of the error in detail. Consequently, the user can recognize readily what inappropriate process has been performed and can therefore deal with the error by a suitable countermeasure.

Further, in order to activate an application in the off mode 261 in which no application is activated as seen in FIG. 9 so that various processes such as a process for displaying a history and a process for displaying a balance are executed, the user must cause such a polling process as illustrated in the flow charts of FIGS. 12 and 13 to be performed in the polling mode 262 to detect a legal contactless IC card 146.

This can suppress a third party from illegally accessing history information of a contactless IC card 146 managed by the PDA 1 and displayed on the LCD unit 28 as hereinafter described.

The CPU 131 having entered into the balance display mode 263 from the polling mode 262 of FIG. 9 now executes a balance display process of displaying the latest balance information of electronic money charged in the contactless IC card 146 based on the acquired history information.

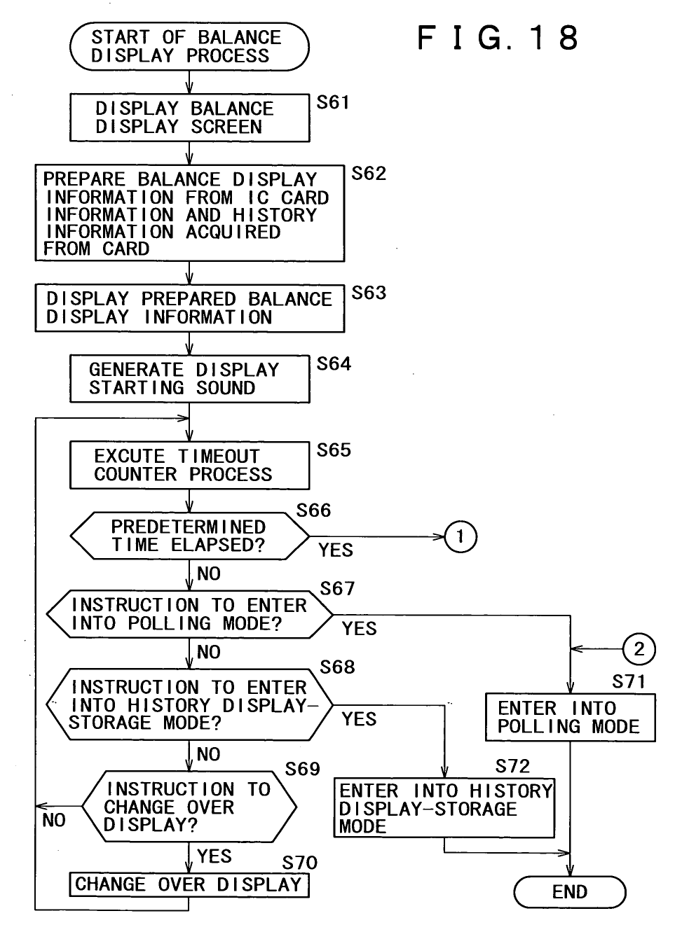

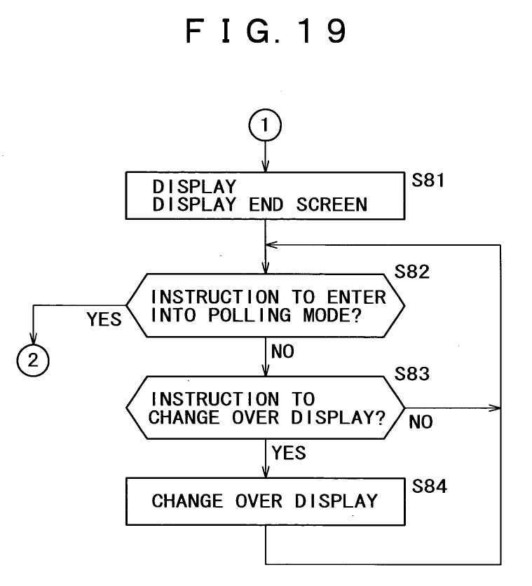

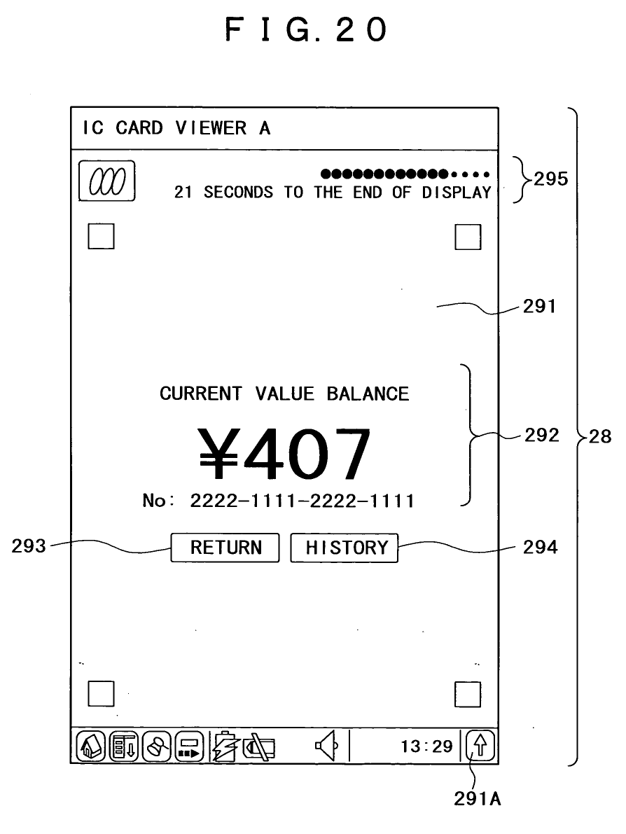

The balance display process by the PDA 1 is described below with reference to the flow charts of FIGS. 18 and 19. Also FIGS. 20 to 23 are referred to as occasion demands.

First at step S61, the CPU 131 controls the LCD unit 28 to display such a balance display screen as shown in FIG. 20. At step S62, the CPU 131 produces balance display information to be displayed on the balance display screen based on the IC card information and the history information acquired from the contactless IC card 146 positioned near to the reader device 37. Then at step S63, the CPU 131 controls the display control section 136 to display the produced balance display information on the balance display screen, and at step S64, the CPU 131 controls the speaker to output predetermined display starting sound prepared in advance.

Referring to FIG. 20, the balance display screen 291 displayed on the LCD unit 28 includes a display of IC card balance information 292 based on the IC card information acquired in response to the request at steps S24 of FIG. 12 and the history information acquired by the process at step S26 of FIG. 12. The IC card balance information 292 relates to an ID number (No.: 2222-1111-2222-1111) of the nearly positioned contactless IC card 146 and the balance (current value balance ¥407) of electronic money charged in the contactless IC card 146. From the display, the user can grasp the current balance of the contactless IC card 146.

The balance display screen 291 further includes a display of a return button 293 and a history button 294. The return button 293 is depressed or tapped by the user to issue an instruction to enter into the polling mode. The history button 294 is depressed or tapped by the user to issue an instruction to enter into a history display-storage mode.

A timeout counter 295 indicative of the remaining display time of the balance display screen 291 is displayed at an upper portion of the balance display screen 291. The balance display screen 291 is displayed only for a predetermined period of time, for example, 30 seconds. The timeout counter 295 includes an indicator whose display changes every time the remaining display time decreases, and a message “T seconds to the end of display”. Here, T is the remaining time and is represented, in the case of the example of FIG. 20, in a unit of second. From the display of the timeout counter 295, the user can grasp the remaining display time of the balance display screen 291.

As hereinafter described, the user will depress the return button 293 to issue an instruction to enter into the polling mode or depress the history button 294 to issue an instruction to enter into the history display-storage mode within a predetermined period of time, for example, 30 seconds, after such a balance display screen 291 as described hereinabove is displayed.

When the display time of the balance display screen 291 exceeds the predetermined time such as 30 seconds, the LCD unit 28 displays such a display end screen as hereinafter described.

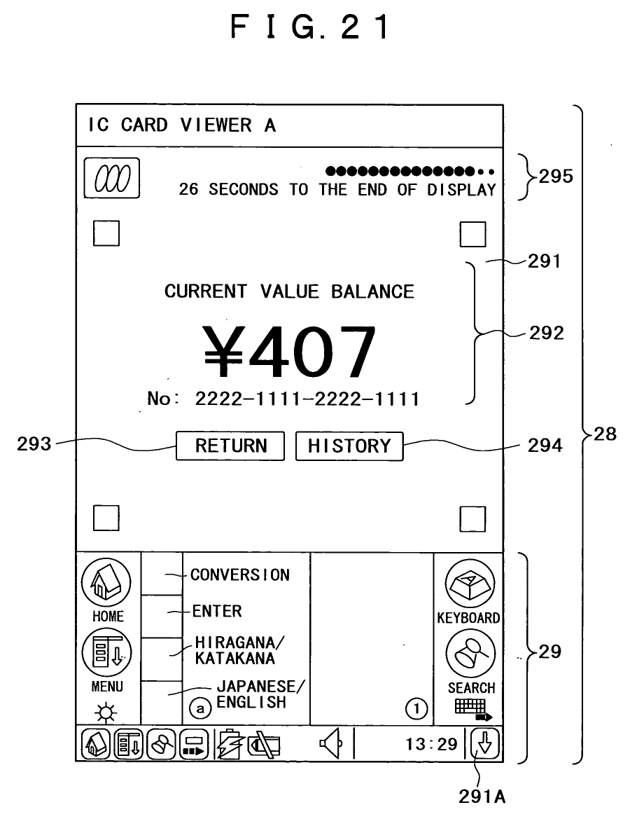

It is to be noted that a display changeover button 291A is displayed at the right lower corner of the LCD unit 28 of FIG. 20. If the user depresses or taps at the display changeover button 291A, then the initial screen 291 being displayed is changed over to such a display as seen in FIG. 21. Where the balance display screen 291 exhibits such a display as seen in FIG. 20, an upwardly directed arrow mark is displayed on the display changeover button 291A.

Referring to FIG. 21, the balance display screen 291 and the character input area 29 are displayed simultaneously on the LCD unit 28. In such a state as seen in FIG. 21, a downwardly directed arrow mark is displayed on a display changeover button 291A. If, in this state, the user operates the display changeover button 291A, that is, taps at the display changeover button 291A of the LCD unit 28, then the CPU 131 controls the display control section 136 to change over the display of the LCD unit 28 so that the LCD unit 28 displays such a balance display screen 291 as shown in FIG. 20.

Referring back to FIG. 18, after the CPU 131 causes such a balance display screen 291 as described above to be displayed through the processes at steps S61 to S64, it advances the processing to step S65. At step S65, the CPU 131 executes a timeout counter process for controlling the display of the timeout counter 295 of the balance display screen 291 to perform a process relating to counting of the display time.

Then at step S66, the CPU 131 discriminates whether or not a predetermined period of time, for example, 30 seconds elapses. If it is discriminated that the predetermined time does not elapse, then the CPU 131 advances the processing to step S67.

At step S67, the CPU 131 discriminates whether or not an instruction to enter into the polling mode is issued by the user. If the CPU 131 discriminates that the user does not depress the return button 293 of FIG. 20 (or FIG. 21), that is, the user does not tap at the return button 293 of the LCD unit 28 and hence an instruction to enter into the polling mode is not issued, then the processing advances to step S68.

At step S68, the CPU 131 discriminates whether or not an instruction to enter into the history display-storage mode is issued by the user. If the CPU 131 discriminates that the user does not depress the history button 294 of FIG. 20 (or FIG. 21), that is, the user does not tap at the history button 294 of the LCD unit 28 and hence an instruction to enter into the history display-storage mode is not issued, then the processing advances to step S69.

At step S69, the CPU 131 discriminates whether or not an instruction to change over the display of the balance display screen 291 is issued by the user. If it is discriminated that the user depresses the display changeover button 291A in FIG. 20 (or FIG. 21), that is, taps at the display changeover button 291A of the LCD unit 28 and hence an instruction to change over the display of the balance display screen 291 is issued, then the processing advances to step S70. At step S70, the CPU 131 changes over the balance display screen 291 as described hereinabove. Thereafter, the CPU 131 returns the processing to step S65 so that the processes at the steps beginning with step S65 are repetitively executed.

If it is discriminated at step S69 that the user does not depress the display changeover button 291A of FIG. 20 (or FIG. 21) and hence an instruction to change over the display of the balance display screen 291 is not issued, then the CPU 131 omits the process at step S70 and returns the processing to step S65 so that the processes at the steps beginning with step S65 are repetitively executed.

As described above, the CPU 131 controls the display control section 136 to repeat the processes at steps S65 to 70 to cause the LCD unit 28 to display the balance display screen 291 for a predetermined period of time, for example, 30 seconds.

On the other hand, if it is discriminated at step S67 that the user depresses the return button 293 of FIG. 20 (or FIG. 21), that is, taps at the return button 293 of the LCD unit 28 and hence an instruction to enter into the polling mode is issued, then the CPU 131 advances the processing to step S71. At step S71, the CPU 131 changes over the mode from the balance display mode 263 of FIG. 9, which is a current mode, to the polling mode 262 and then ends the balance display process.

If it is discriminated at step S68 that the user depresses the history button 294 of FIG. 20 (or FIG. 21), that is, taps at the history button 294 of the LCD unit 28 and hence an instruction to enter into the history display-storage mode is issued, then the CPU 131 advances the processing to step S72. At step S72, the CPU 131 changes over the mode from the balance display mode 263 of FIG. 9, which is a current mode, to the history display-storage mode 264 and then ends the balance display process.

If it is discriminated at step S66 that a predetermined period of time elapses after the balance display screen 291 is displayed for a predetermined period of time in such a manner as described above, then the CPU 131 advances the processing to step S81 of FIG. 19.

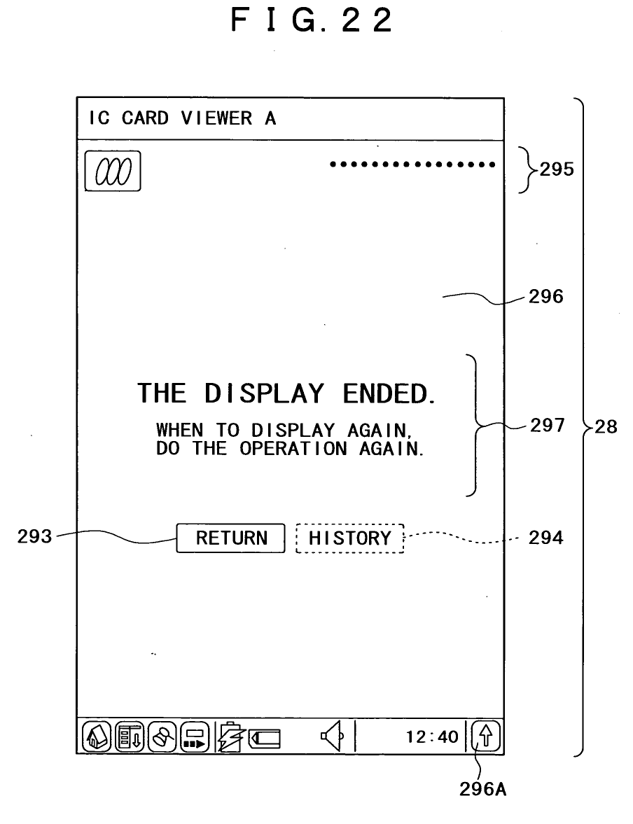

At step S81 of FIG. 19, the CPU 131 controls the display control section 136 to display such a display end screen as shown in FIG. 22 on the LCD unit 28 in place of the balance display screen 291 having been displayed on the LCD unit 28.

Referring to FIG. 22, the display end screen 296 displayed on the LCD unit 28 includes a display of a message 297 “The display ended. When to display again, do the operation again”. From the message 297, the user can grasp that the balance display is ended and can recognize what operation should be performed subsequently.

The display end screen 296 includes, in addition to the display of the message 297, a display of a return button 293, a history button 294 and a timeout counter 295. The timeout counter 295 is displayed in a timeout state.

The history button 294 is displayed in a state wherein it cannot be depressed by the user, and even if the user taps at the history button 294 of the LCD unit 28, transition into the history display-storage mode is not performed different from that in the case when the history button 294 of the balance display screen 291 of FIG. 20 (or FIG. 21) is depressed.

In particular, when the user wants to issue an instruction to enter into another mode on the display end screen 296, the user can only depress the return button 293 to issue an instruction to enter into the polling mode.

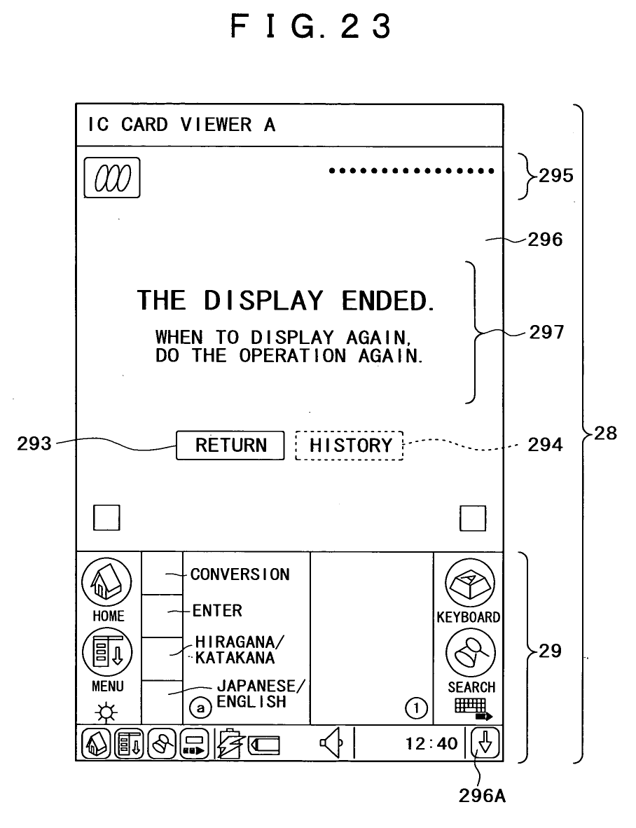

It is to be noted that a display changeover button 296A is displayed at a right lower end of the LCD unit 28 of FIG. 22. The display changeover button 296A is used to change over the display of the display end screen 296. In the state of FIG. 22, an upwardly directed arrow mark is displayed on the display changeover button 296A. If the user depresses the display changeover button 296A, then the display end screen 296 is changed over to such a display as shown in FIG. 23 wherein a display end screen 296 and a character input area 29 are displayed simultaneously on the LCD unit 28.

In this instance, a downwardly directed arrow mark is displayed on the display changeover button 296A. If the user depresses the display changeover button 296A, then the CPU 131 controls the display control section 136 to change over the display end screen 296 to such a display as shown in FIG. 22.

In other words, every time the user depresses the display changeover button 296A, the display size of the display end screen 296 changes and the display end screen 296 alternately changes over between such displays as shown in FIGS. 22 and 23.

Referring back to FIG. 19, after the CPU 131 controls the LCD unit 28 to display such a display end screen 296 as described above through the process at step S81, it discriminates at step S82 whether or not an instruction to enter into the polling mode is issued by the user.

If it is discriminated that the user does not depress the return button 293 of FIG. 22 (or FIG. 23) and hence an instruction to enter into the polling mode is not issued, then the CPU 131 advances the processing to step S83. At step S83, the CPU 131 discriminates whether or not an instruction to change over the display is issued by the user.

If it is discriminated that the user depresses the display changeover button 296A of FIG. 22 (or FIG. 23), that is, the user taps at the display changeover button 296A of the LCD unit 28 to issue an instruction to change over the display of the display end screen 296, then the CPU 131 controls the display control section 136 to change over the display of the display end screen 296 displayed on the LCD unit 28 at step S84. In particular, if the display of the display end screen 296 is in such a state of FIG. 22, then it is changed over to the state of FIG. 23, but if the display of the display end screen 296 is in such a state of FIG. 23, then it is changed over to the state of FIG. 22 conversely. Then, the CPU 131 returns the processing to step S82, so that the processes at the steps beginning with step S82 are repetitively executed.

If it is discriminated at step S83 that an instruction to change over the display is not issued, then the CPU 131 omits the process at step S84 and returns the processing to step S82 so that the processes at the steps beginning with step S82 are repetitively executed.

The CPU 131 stands by until the user depresses the return button 293 while repetitively executing the processes at steps S82 to S84 in such a manner as described above.

If it is discriminated at step S82 that the user depresses the return button 293, that is, the user taps at the return button 293 of the LCD unit 28 to issue an instruction to enter into the polling mode, then the CPU 131 advances the processing to step S71 of FIG. 18. At step S71, the CPU 131 changes over the mode from the balance display mode 263 of FIG. 9, which is a current mode, to the polling mode 262 and then ends the balance display process.

The CPU 131 executes such a balance display process as described above in the balance display mode of FIG. 9 to control the LCD unit 28 to display the balance information of the contactless IC card 146 positioned in the proximity of the reader device 37 for a predetermined period of time, for example, 30 seconds in such a manner as described above. Then, when the predetermined period of time elapses, the CPU 131 controls the display control section 136 to display the display end screen 296 in place of the balance display screen 291 on the LCD unit 28.

As a result, even when the user operates a contactless IC card 146 so as to be positioned near to the reader device 37 in the polling mode so that IC card information or/and history information are read into the PDA 1, balance information is displayed only for a predetermined period of time determined in advance. Therefore, for example, such a situation that, while balance information remains displayed, the user leaves the PDA 1 to allow a third party to read the balance information can be prevented.

Further, as hereinafter described, in order to read history information and so forth read in by the PDA 1, the user must depress the history button 294 on the balance display screen 291 described hereinabove. Accordingly, by limiting the display time of the balance display screen 291 as described above, for example, such a situation that, while the user leaves balance information displayed, the user leaves the PDA 1 to allow the balance information to be read by a third party can be prevented.

In particular, the PDA 1 cannot change over the mode from the polling mode 262 to the history display-storage mode 264 without through the balance display mode 263, and further, the display time of the balance display screen 291 displayed in the balance display mode 263 is limited. Consequently, the PDA 1 can safely manage and display IC card information and history information of the contactless IC card 146 read in in the polling mode 262.

In such a balance display process as described above, the PDA 1 having changed over the mode from the balance display mode 263 of FIG. 9 to the history display and-storage mode 264 through the process at step S72 of FIG. 18 executes a history information display-storage process which is a process relating to display and storage of history information of a contactless IC card 146.

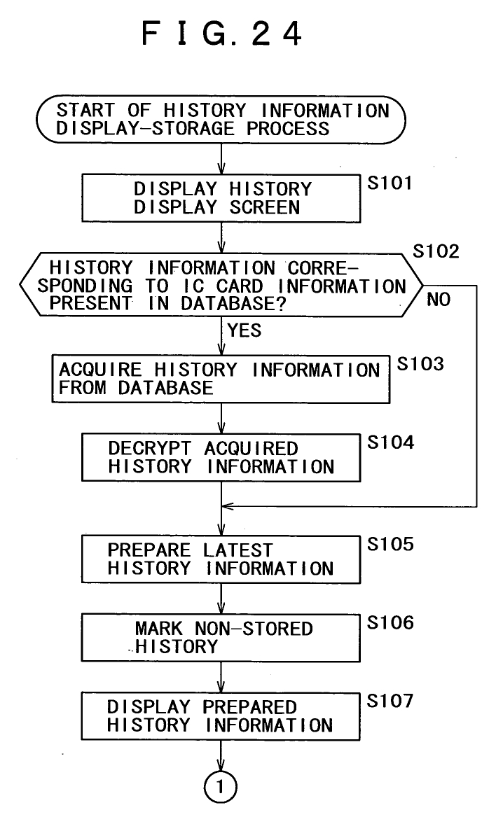

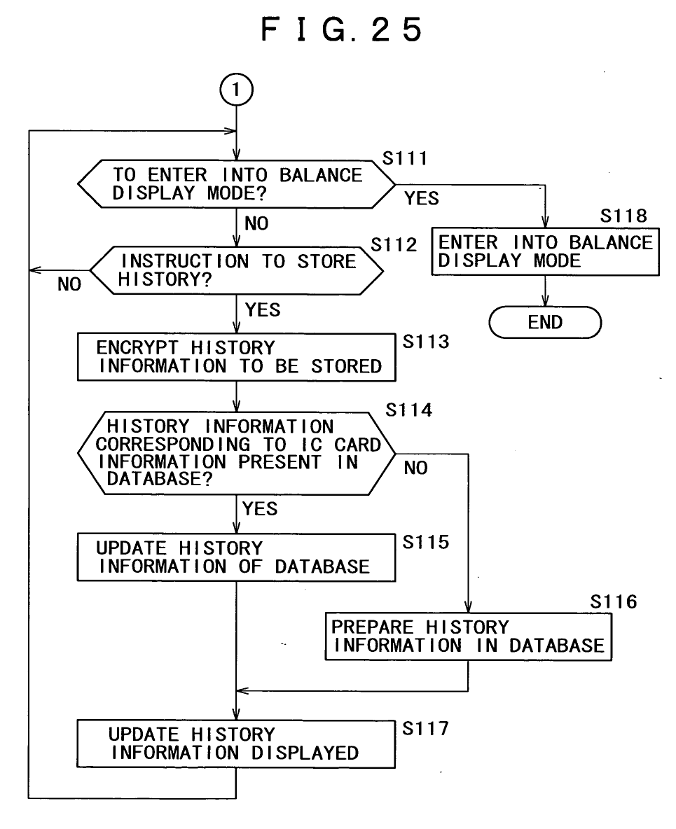

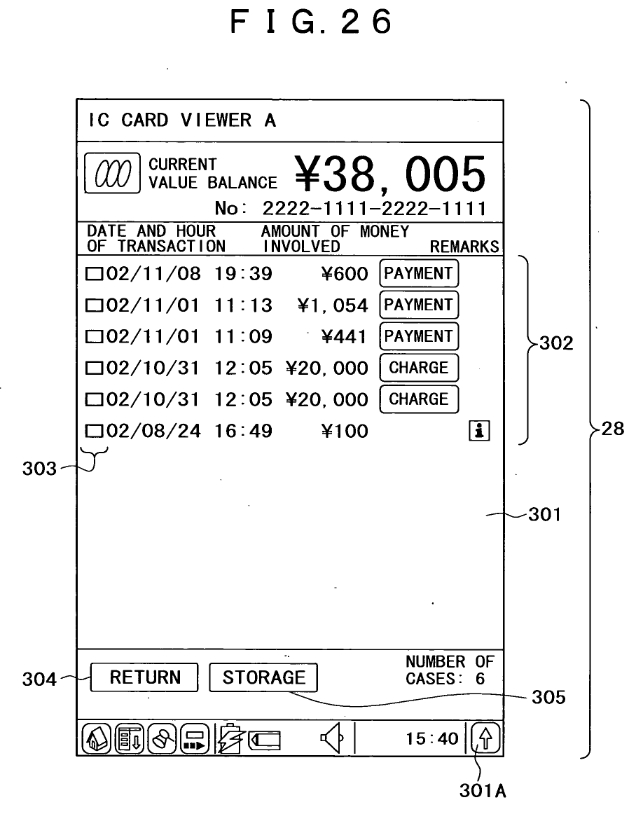

The history information display-storage process by the PDA 1 is described below with reference to the flow charts of FIGS. 24 and 25. Also FIGS. 26 to 31 are referred to as occasion demands.

First at step S101, the CPU 131 displays a history display screen. Then at step S102, the CPU 131 controls the storage section 139 and so forth to discriminate whether or not the history information corresponding to the IC card information acquired from the contactless IC card 146 in the polling mode 262 is present within a database of history information formed from the storage section 139 and so forth.

The PDA 1 uses the history information acquired from the contactless IC card 146 to produce and store a database for the contactless IC card 146 in and into a predetermined storage region of the storage section 139, the memory card 143 loaded in the slot 64 or the RAM 133.

At step S102, the CPU 131 refers to the database to discriminate whether or not history information corresponding to the IC card information acquired in the present operation cycle, that is, corresponding to the contactless IC card 146 from which the IC card information has been read in, was read in formerly and is registered in the database.

Then, if it is discriminated that corresponding history information is present in the database, then the CPU 131 advances the processing to step S103, at which it acquires the history information from the database. Then at step S104, the CPU 131 decrypts the history information acquired at step S104 using a predetermined encryption key (decryption key).

Before the PDA 1 registers the IC card information or history information acquired from the contactless IC card 146, it encrypts the IC card information or history information. Therefore, the encrypted IC card information or history information is stored into a predetermined storage region. Consequently, the stored information can be prevented from being read illegally, and the IC card information and the history information can be managed safely.

The CPU 131 having decrypted the history information acquired from the database advances the processing to step S105. At step S105, the CPU 131 uses the IC card information and the history information acquired from the contactless IC card 146 and the history information and so forth acquired from the database to produce the latest history information for display.

Then at step S106, the CPU 131 performs such a marking process as hereinafter described for non-stored history information formed from the history information acquired from the contactless IC card 146. Then at step S107, the CPU 131 controls the display control section 136 to display the history information for display produced in such a manner as described above on the history display screen.

On the other hand, if it is discriminated at step S102 that history information corresponding to the IC card information acquired from the contactless IC card 146 is not present in the database, then the CPU 131 omits the processes at steps S103 and S104 and advances the processing directly to step S105. At step S105, the CPU 131 uses the IC card information and the history information acquired from the contactless IC card 146 to produce the latest history information for display. Then at step S106, the CPU 131 marks the non-stored history information (all pieces of the history information), and at step S107, the CPU 131 controls the display control section 136 to display the produced history information for display.

FIG. 26 shows an example of a configuration of the history display screen displayed on the LCD unit 28.

Referring to FIG. 26, the history display screen 301 displayed on the LCD unit 28 includes a display of a history information table 302 which includes the date and hour of transaction at which a commercial transaction is performed, the amount of money involved in the commercial transaction and the remarks including transaction contents or the like.

The history information table 302 includes pieces of history information displayed in a juxtaposed relationship in order from above such that a newer piece of information is positioned above an older piece of information. For example, the third history information from above indicates that an amount of money of 441 yens (¥441) was paid at 11:09 on Nov. 1, 2002 (Feb. 11, 2001 11:09).

A non-stored piece of history information in the history information table 302 is displayed with a predetermined mark 303 added to the left end of the row. In FIG. 26, the mark 303 of a rectangular shape is displayed for all of six pieces of history information in the history information table 302, and this indicates that all of the pieces of history information are formed from the history information read in from the contactless IC card 146 in the present operation cycle.

Incidentally, though not displayed on the history display screen 301, an ID number is allocated to each of the pieces of history information included in the history information of the contactless IC card 146 and the history information managed by the database. Consequently, it can be discriminated what numbered piece of information of the contactless IC card 146 each piece of history information is.

Since the storage area of the contactless IC card 146 is very small, the contactless IC card 146 can store only a predetermined small number of pieces of history information, for example, six pieces of history information. Accordingly, if a number of transactions exceeding the predetermined number such as six are performed, then the contactless IC card 146 deletes the oldest piece of history information and stores the latest history information instead. In other words, the contactless IC card 146 normally has the predetermined number of pieces such as six pieces of the latest history information stored therein.

Accordingly, also the history information read into the PDA 1 from the contactless IC card 146 includes the predetermined number of pieces such as six pieces of the latest information, and the pieces of history information may not necessarily be continuous to the history information registered already in the database. In such an instance, if history information is registered into the database, then discontinuous pieces of history information, that is, pieces of history information having allocated ID numbers which are discontinuous to each other, are registered into the database.

Where the ID numbers of the pieces of history information of the history information table 302 are not continuous in this manner, that is, a piece of history information which has been erased and does not remain is involved between the pieces of history information, a broken line may be displayed at a corresponding portion of the history information table 302 of the history display screen 301.

Further, when all pieces of history information of the history information table 302 cannot be displayed at a time on the history display screen 301, a scroll bar or the like may be displayed so that the user can scroll the history information table 302. Or, the font size of the history information table 302 may be changed in response the number of pieces of history information to be displayed.

A return button 304 and a storage button 305 are displayed at a lower portion of the history display screen 301. The return button 304 is depressed by the user to issue an instruction to enter into the balance display mode 263. The storage button 305 is depressed by the user to issue an instruction to store history information of the history information table 302 displayed on the history display screen 301 into the database.

In addition to the displayed items described above, the history display screen 301 includes a display of the ID number of the contactless IC card 146 corresponding to the history information displayed, balance information of electronic money currently charged and the total number of pieces of history information of the history information table 302 displayed on the history display screen 301.

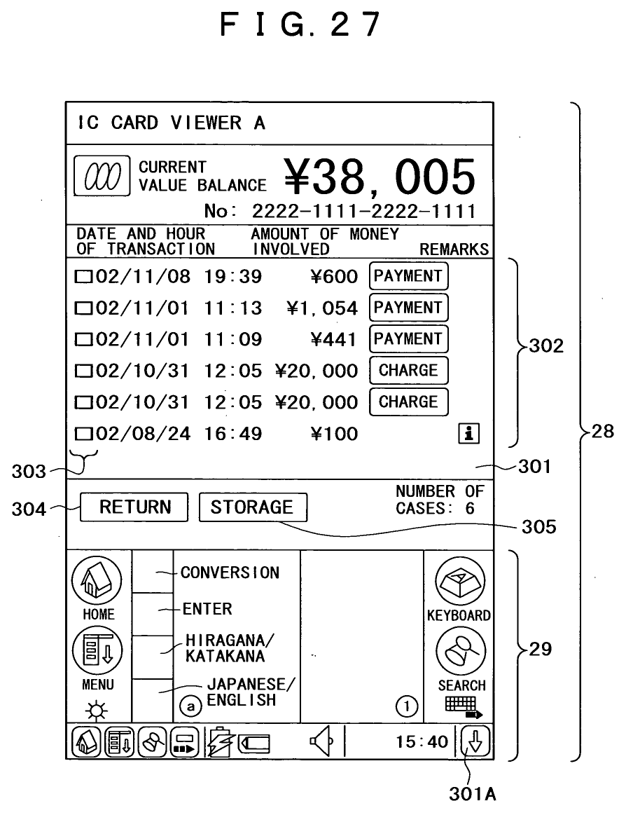

Further, in FIG. 26, a display changeover button 301A is displayed at a right lower end of the LCD unit 28 and issues an instruction to change over the display size of the history display screen 301 if it is depressed. Where the history display screen 301 is displayed over the overall area of the LCD unit 28 as shown in FIG. 26, an upwardly directed arrow mark is displayed on the display changeover button 301A. If, in this state, the user depresses the display changeover button 301A, that is, if the user taps at the display changeover button 301A of the LCD unit 28, then the CPU 131 controls the display control section 136 to change over the display of the history display screen 301 to such a display as shown in FIG. 27.

In FIG. 27, a history display screen 301 and a character input area 29 are displayed on the LCD unit 28. The history display screen 301 shown in FIG. 27 has a configuration basically similar to that in FIG. 26 except that it has a display size different from that of the history display screen of FIG. 26. However, since the region of the history display screen 301 of FIG. 27 in which the history information table 302 is displayed is smaller than that of FIG. 26, the number of pieces of history information to be displayed at the same time is different from that of FIG. 26.

In FIG. 27, a downwardly directed arrow mark is displayed on the display changeover button 301A. If, in this state, the user depresses the display changeover button 301A, that is, if the user taps at the display changeover button 301A of the LCD unit 28, then the CPU 131 controls the display control section 136 to change over the display of the history display screen 301 to such a display as shown in FIG. 26.

In particular, every time the user depresses the display changeover button 301A, the display size of the history display screen 301 alternately changes over from the state of FIG. 26 to the state of FIG. 27 and conversely from the state of FIG. 27 to the state of FIG. 26.

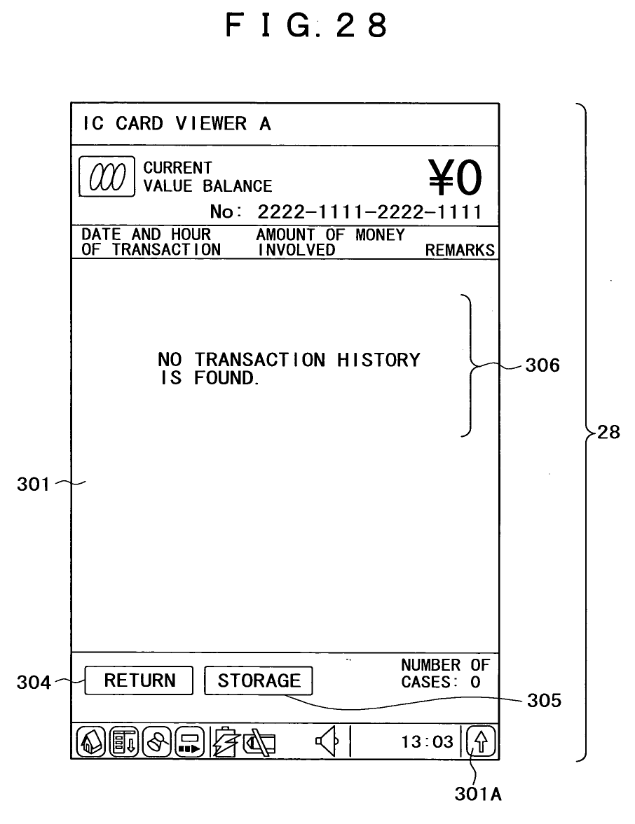

On the other hand, when the history information read in from the contactless IC card 146 is null, that is, when history information is read in from a contactless IC card 146 which has been used no time for a commercial transaction at all, naturally the database does not include history information corresponding to the contactless IC card 146. Therefore, a message 306 “No transaction history is found” is displayed on the history display screen 301 displayed on the LCD unit 28 as seen in. FIG. 28 in place of the history information table 302. Consequently, the user can grasp readily that no history information is present.

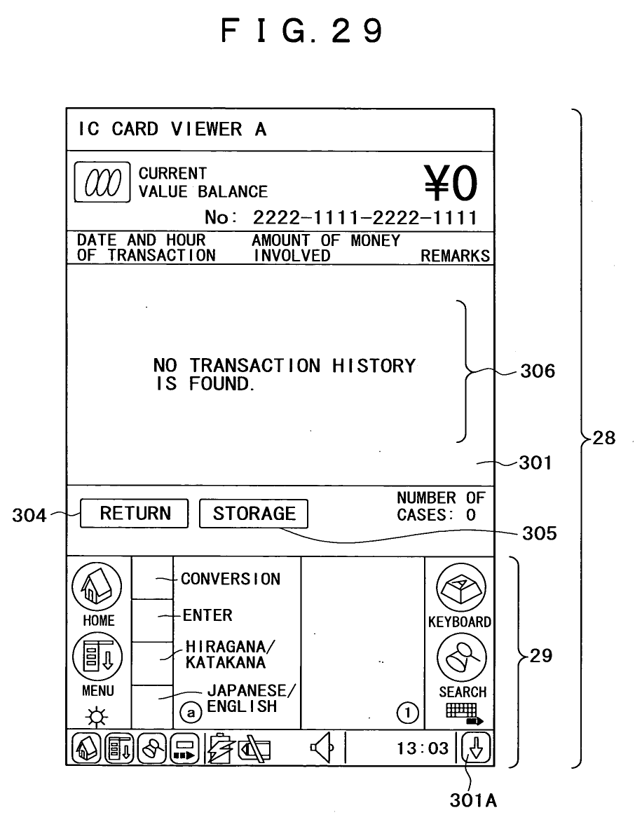

It is to be noted that, also in the case of FIG. 28, if the user depresses the display changeover button 301A, then the display size of the history display screen 301 can be changed so that the character input area 29 can be displayed simultaneously as shown in FIG. 29.

Referring back to FIG. 24, the CPU 131 having caused the history information to be displayed through the process at step S107 advances the processing to step S111 of FIG. 25.

At step S111, the CPU 131 discriminates whether or not it should ender into the balance display mode.

If it is discriminated that the return button 304 is not depressed, that is, the user does not tap at the return button 304 of the LCD unit 28, on any of the displays of FIGS. 26 to 29 and hence the mode should not be changed to the balance display mode, then the CPU 131 advances the processing to step S112. At step S112, the CPU 131 discriminates whether or not an instruction to store history information is issued.

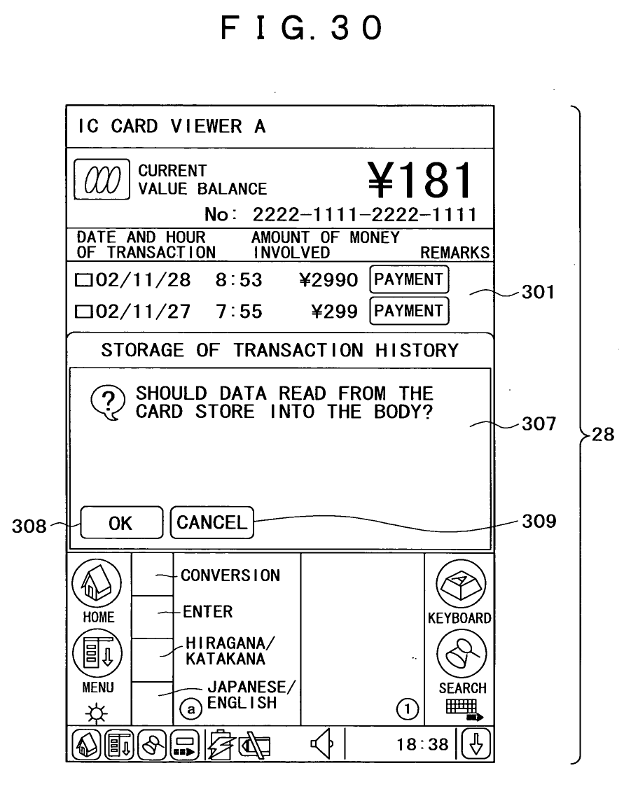

If the user depresses the storage button 305, that is, taps at the storage button 305 of the LCD unit 28, in any of the displays of FIGS. 26 to 29, then the CPU 131 controls the display control section 136 to display such a history storage confirmation screen as shown in FIG. 30 on the LCD unit 28.

Referring to FIG. 30, a history storage confirmation screen 307 displayed in an overlapping relationship with the history display screen 301 on the LCD unit 28 includes a display of a message “Should data read from the card be stored into the body?”, an OK button 308 and a cancel button 309. The OK button 308 is depressed by the user to issue an instruction to store the history. The OK button 308 is depressed by the user to cancel the storage of the history.

The user will depress the storage button 305 on the history display screen 301 and further depress the OK button 308 on the history storage confirmation screen 307 displayed for confirmation and then issue an instruction to store the history.

After it is discriminated that an instruction to store the history is issued in such a manner as described above, the CPU 131 advances the processing to step S113, at which it encrypts the history information to be stored.

Then at step S114, the CPU 131 discriminates whether or not history information corresponding to the IC card information, that is, history information corresponding to the contactless IC card 146 same as the history information to be stored, is present in the database. If the CPU 131 discriminates that such history information is present, then it updates the history information of the database with the history information to be stored at step S115. Further, at step S117, the CPU 131 updates the displayed history information by erasing the displayed mark to the history information or the like. Then, the CPU 131 returns the processing to step S111 so that the processes at the steps beginning with step S111 are repetitively executed.

On the other hand, if it is discriminated at step S114 that history information corresponding to the IC card information is not present in the database, then the CPU 131 advances the processing to step S116. At step S116, the CPU 131 newly produces history information in the database, and at step S117, the CPU 131 updates the displayed history information. Thereafter, the CPU 131 returns the processing to step S111 so that the processes at the processes beginning with step S111 are repetitively executed.

In particular, for example, a database 320 formed in the storage area of the storage section 139 has history information registered therein for each ID number of IC card information, that is, for each of compatible contactless IC cards 146. When the CPU 131 tries to store the latest history information, it searches for history information corresponding to one of the contactless IC cards 146 to which the history information corresponds. Then, if such history information is found, then the CPU 131 updates the searched out history information with the history information to be stored. However, when such corresponding history information is not found, then the CPU 131 registers the history information to be stored in a corresponding relationship to the IC card information newly into the database 320.

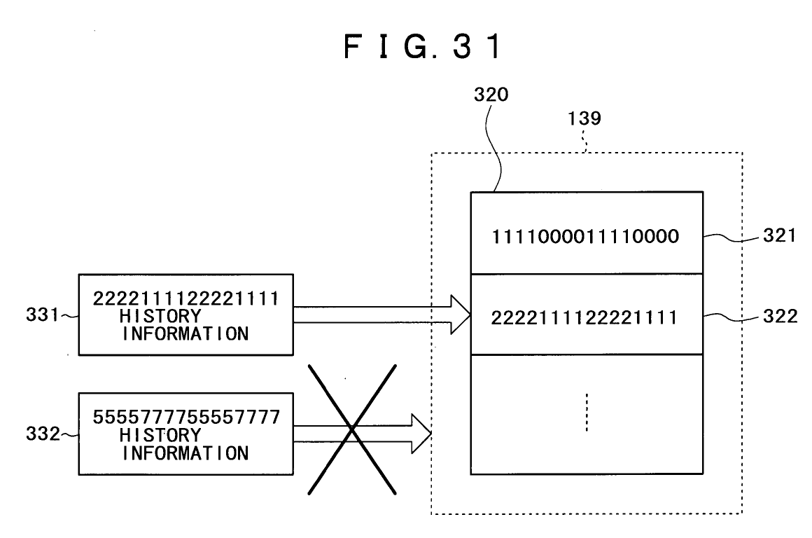

For example, in the database 320 shown in FIG. 31, it includes history information 321 corresponding to a contactless IC card 146 whose ID number is “1111-0000-1111-0000” and history information 322 corresponding to another contactless IC card 146 whose ID number is “2222-1111-2222-1111”.

If an instruction is issued to store the latest history information 331 corresponding to the contactless IC card 146 whose ID number is “2222-1111-2222-1111” into the database 320, then the CPU 131 searches for the history information 322 from within the database 320 and updates the contents of the searched out history information 332 using the history information 331.

On the other hand, if an instruction is issued to store the latest history information 332 corresponding to the contactless IC card 146 whose ID number is “5555-7777-5555-7777” into the database 320, then the CPU 131 searches the database 320. However, since the database 320 does not include history information corresponding to the history information 33.2, the CPU 131 newly produces history information 332 and registers it into the database 320.

Incidentally, if it is discriminated at step S112 that an instruction to store the history is not issued because the user does not depress the storage button 305 of the history display screen 301 or the cancel button 309 is depressed on the history storage confirmation screen 307, then the CPU 131 returns the processing to step S111 so that the processes at the steps beginning with step S111 are repetitively executed.

The CPU 131 repeats the processes at steps S111 to S117 to perform a process for the history display screen 301 in such a manner as described above.

On the other hand, if it is discriminated at step S111 that the mode should be changed to the balance display mode because the user depresses the return button 304, then the CPU 131 advances the processing to step S118, at which it enters into the balance display mode and ends the history information display-storage process.

Since the PDA 1 stores history information read in from the contactless IC card 146 in such a manner as described above, the user can read also history information in the past in addition to the history information recorded in the contactless IC card 146.

Further, the PDA 1 stores the history information acquired from the contactless IC card 146 as information of the corresponding individual contactless IC card 146 into the database 320 produced in the storage section 139 or the like. Since the PDA 1 automatically produces the database 320 formed from history information of corresponding individual contactless IC cards 146 in this manner, the history information and so forth can be managed safely and readily.

Furthermore, the PDA 1 displays only history information corresponding to a contactless IC card 146 positioned near to the reader device 37 on the history display screen 301 only when the user moves the contactless IC card 146 to approach the reader device 37 in the polling mode 262 and then depresses the history button 294 on the balance display screen 291 which is displayed only for a predetermined period of time in the balance display mode 263. Therefore, the history information can be prevented from being read illegally by a third party and therefore can be displayed safely.

Incidentally, when the process at step S49 of FIG. 13 is executed in the polling mode 262 of FIG. 9 to enter into the history deletion mode 265, the PDA 1 executes a history deletion process of deleting history information registered in the database 320 formed in the storage area of the storage section 139 or the like.

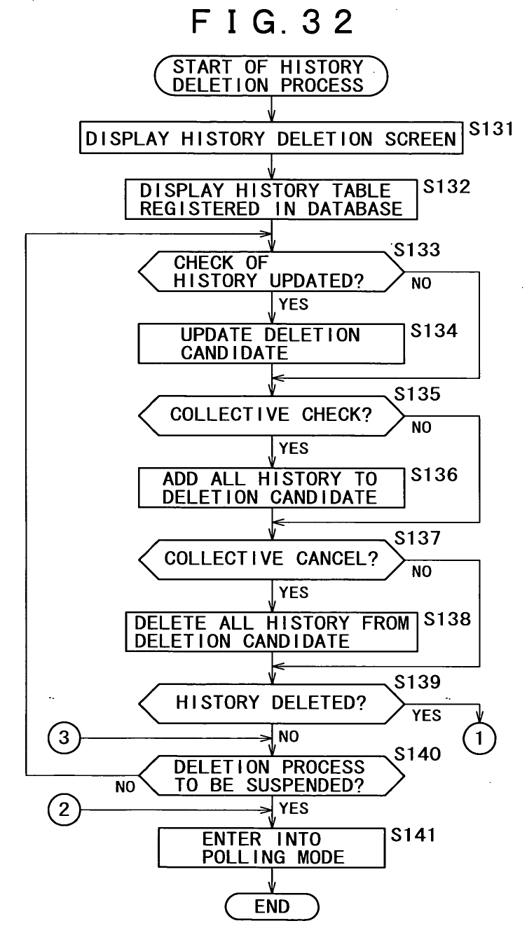

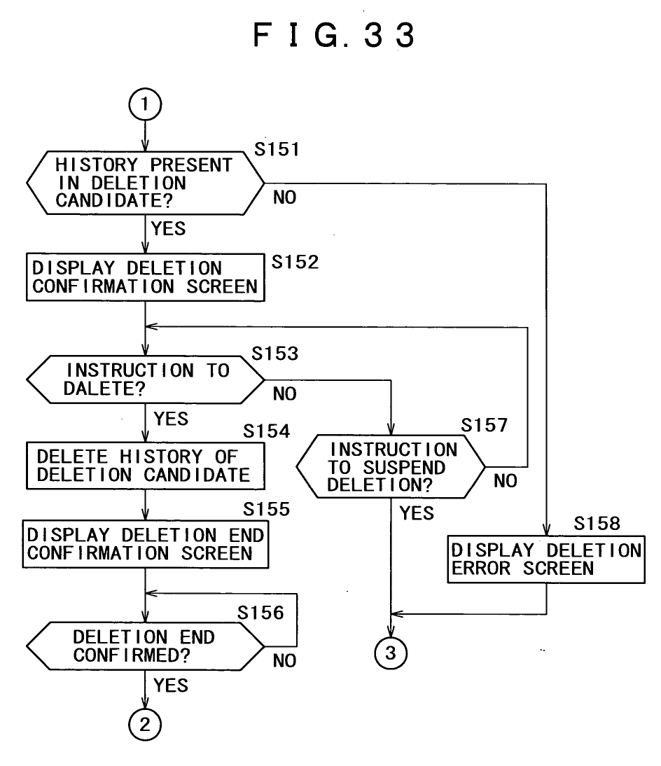

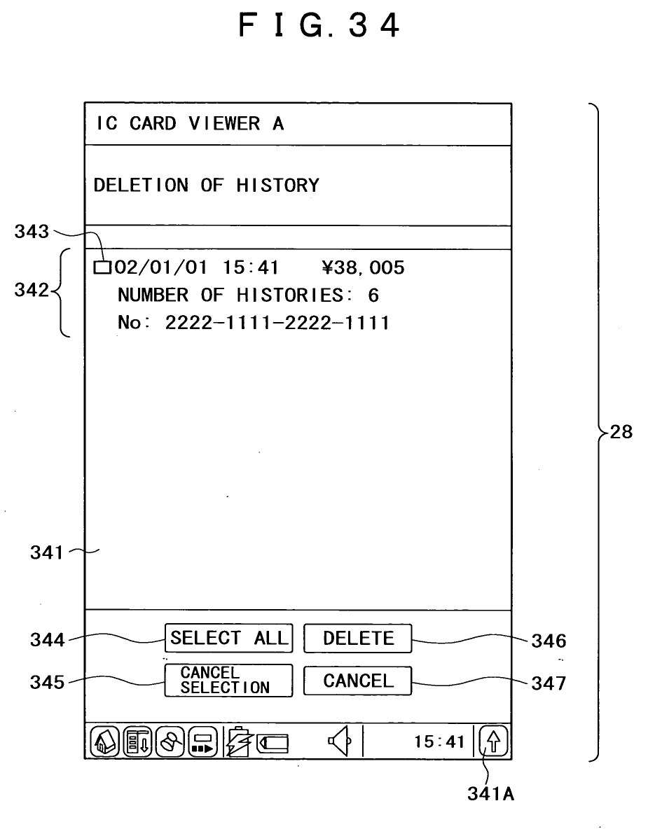

The history deletion process by the PDA 1 is described with reference to the flow charts of FIGS. 32 and 33. Also FIGS. 34 to 38 are referred to as occasion demands.

First at step S131, the CPU 131 controls the display control section 136 to display the history deletion screen. Then at step S132, the CPU 131 controls a portion of the storage section 139 or the like which includes a storage area into which a database is formed so that a history table registered in the database is displayed on the history deletion screen.

FIG. 34 shows an example of a configuration of the history deletion screen displayed on the LCD unit 28.

Referring to FIG. 34, the history deletion screen 341 displayed on the LCD unit 28 includes a display of the history table described above as history information 342 for the individually corresponding contactless IC card 146, that is, as history information 342 for the individual ID number.

The history information 342 includes the date and hour on which a history was registered last, the balance information, the number of registered histories, the ID number of corresponding contactless IC card and so forth.

Further, the history information 342 includes a check box 343 so that the history information 342 to be deleted by the user can be selected as hereinafter described.

It is to be noted that, where the number of all pieces of the history information 342, that is, the number of histories of the table of history information registered in the database, is so great that the history information 342 cannot be displayed at a time on the history deletion screen 341, a scroll bar may be displayed so that the user can scroll the history information 342 displayed on the history deletion screen 341. The font size of the history information 342 may be changed in response to the number of pieces of history information 342 to be displayed, or the history information 342 may be displayed in a unit of one page which includes a number of pieces of history information 342 to be displayed at a time. In this instance, a changeover button for changing over the page of history information 342 to be displayed is provided separately.

A select all button 344, a cancel selection button 345, a delete button 346 and a cancel button 347 are provided at a lower portion of the history deletion screen 341. The select all button 344 is depressed by the user to apply a check mark to all check boxes 343 to select all history information. The cancel selection button 345 is depressed by the user to cancel all of the check marks in the check boxes 343. The delete button 346 is depressed by the user to delete the history information 342 to whose check boxes 343 a check mark is applied. The cancel button 347 is depressed by the user to suspend the history deletion process.

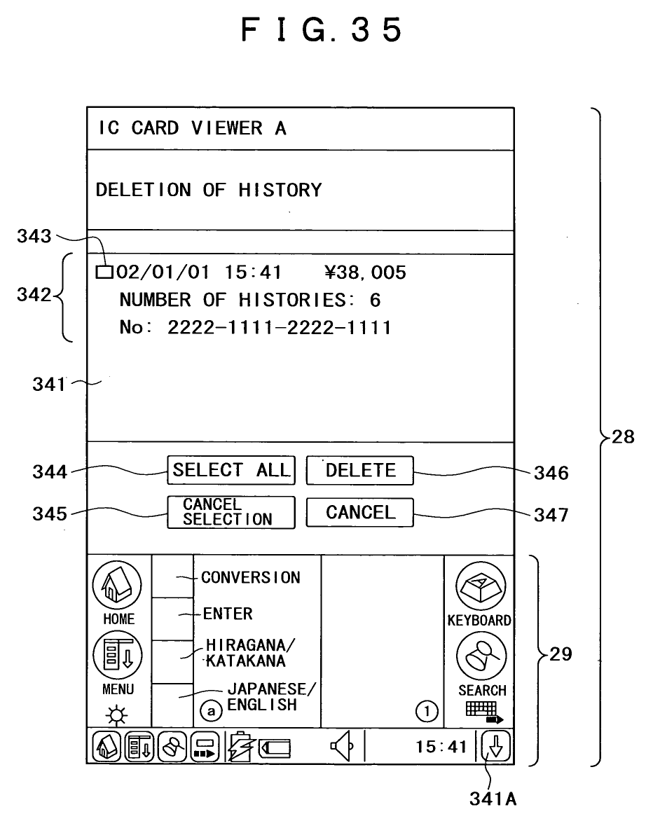

A display changeover button 341A is provided at a right lower corner of the LCD unit 28 and is depressed by the user to change over the display size of the history deletion screen 341. If the user depresses the display changeover button 341A in the state of FIG. 34, then the display size of the history deletion screen 341 is changed over and the history deletion screen 341 and a character input area 29 are displayed simultaneously on the LCD unit 28 as shown in FIG. 35.

It is to be noted that, if the user depresses the history deletion screen 341 in the state of FIG. 35, then the display size of the history deletion screen 341 is changed back to that shown in FIG. 34.

Referring back to FIG. 32, the CPU 131 having completed the process at step S132 then discriminates at step 133 whether or not a check of a history is updated because the user checks a check box 343 of the history deletion screen 341, that is, the user taps a check box 343 of the LCD unit 28 in a state wherein the check box 343 is not checked, or the user cancels a check of a check box 343 of the history deletion screen 341, that is, the user taps at the check box 343 of the LCD unit 28 in a state wherein the check box 343 is in a checked state.

If it is discriminated that the check of the history is updated, then the CPU 131 updates information regarding a deletion candidate or candidates stored in the RAM 133 or the like at step S134. The CPU 131 lists up those of the histories whose check box 343 is checked as deletion candidates and stores them into the RAM 133 or the like, and then upon deletion of a history, the histories listed up as the deletion candidates are deleted. At step S134, the CPU 131 updates information relating to the deletion candidates in accordance with updating of the states of the check boxes 343 by the user.

The CPU 131 having updated the deletion candidate advances the processing to step S135.

On the other hand, if it is discriminated at step S133 that the checks of the histories are not updated, then the CPU 131 omits the process at step S134 and advances the processing to step S135.

At step S135, the CPU 131 discriminates whether or not collective checking should be performed in accordance with a collective checking instruction inputted by depression of the select all button 344 by the user.

If it is discriminated that the user depresses the select all button 344 to issue an instruction to perform collective checking, then the CPU 131 places all of the check boxes 343 into a checked state to add all histories to the deletion candidates described above at step S136. The CPU 131 having completed the process at step S136 advances the processing to step S137.

On the other hand, if it is discriminated at step S135 that the user does not depress the select all button 344 and hence does not issue an instruction to perform collective checking, then the CPU 131 omits the process at step S136 and advances the processing to step S137.

At step S137, the CPU 131 discriminates whether or not the user depresses the cancel selection button 345 to discriminate whether or not collective cancellation should be performed. If it is discriminated that the user depresses the cancel selection button 345 to issue an instruction to cancel the checks of all of the check boxes 343 and the checks should be cancelled collectively in accordance with the instruction, then the CPU 131 places all of the check boxes 343 into a non-checked state to delete all histories from the deletion candidates at step S138. Then, the CPU 131 advances the processing to step S139.

On the other hand, if it is discriminated at step S137 that the user does not depress the cancel selection button 345 and hence collective cancellation should not be performed, then the CPU 131 omits the process at step S138 and advances the processing to step S139.

At step S139, the CPU 131 discriminates whether or not the user depresses the delete button 346 to discriminate whether or not a history should be deleted.

If the user does not depress the delete button 346 and does not issue an instruction to delete a history and hence deletion of a history should not be performed, then the CPU 131 advances the processing to step S140, at which it discriminates whether or not the deletion process should be suspended.

If it is discriminated that the user does not depress the cancel button 347 and hence the deletion process should not be suspended, then the CPU 131 returns the processing to step S133 so that the processes at the steps beginning with step S133 are repetitively executed.

On the other hand, if it is discriminated at step S140 that the user depresses the cancel button 347 to issue an instruction to suspend the deletion process and the deletion process should be suspended in accordance with the instruction, then the CPU 131 changes over the mode thereof from the history deletion mode 265 at present to the polling mode 262. Then, the CPU 131 ends the history deletion process.

Incidentally, if it is discriminated at step S139 that the user depresses the delete button 346 to issue an instruction to delete a history and hence a history should be deleted in accordance with the instruction, then the CPU 131 advances the processing to step S151 of FIG. 33.

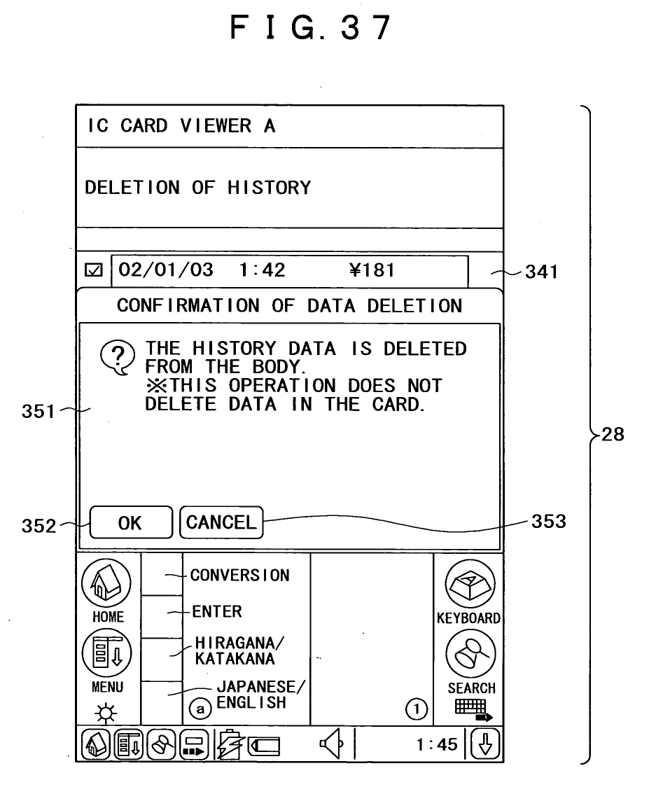

At step S151 of FIG. 33, the CPU 131 discriminates whether or not a deletion candidate stored in the RAM 133 has a history. If a deletion candidate has a history, that is, if a history whose check box 343 is checked is present, then the CPU 131 controls the display control section 136 to display such a deletion confirmation screen as shown in FIG. 37 on the LCD unit 28 at step S152.

In FIG. 37, the deletion confirmation screen 351 displayed in an overlapping relationship with the history deletion screen 341 on the LCD unit 28 includes a message “The history data is deleted from the body. OK?” and another message “This operation does not delete data in the card”. Consequently, the user can recognize readily that an operation of deleting a history stored in the PDA 1 is proceeding.

Further, the deletion confirmation screen 351 includes a display of an OK button 352 depressed by the user to delete history data from the database and a cancel button 353 depressed by the user to suspend the deletion of history data.

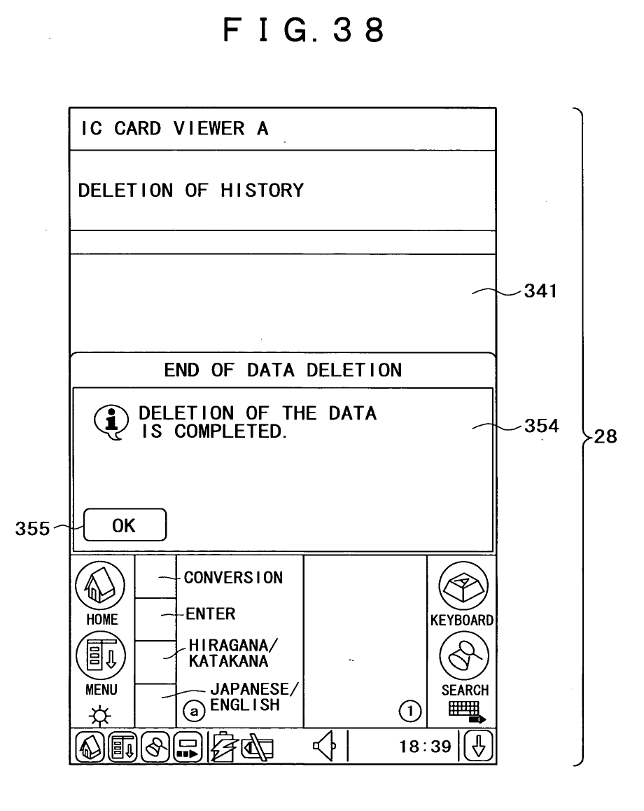

The CPU 131 having caused such a deletion confirmation screen 351 as described above to be displayed discriminates at step S153 whether or not the user depresses the OK button 352 to issue an instruction to delete a history. If it is discriminated that an instruction to delete a history is issued, then the CPU 131 deletes history data of the deletion candidates from the database at step S154. Then at step S155, the CPU 131 controls the display control section 136 to display such a deletion end confirmation screen as shown in FIG. 38 on the LCD unit 28.

Referring to FIG. 38, the deletion end confirmation screen 354 displayed in an overlapping relationship with the history deletion screen 341 on the LCD unit 28 includes a display of a message “Deletion of the data is completed.” and an OK button 355 for being depressed by the user to issue a notification that the deletion end is confirmed.

The CPU 131 having caused the deletion end confirmation screen 354 to be displayed discriminates at step S156 whether or not the OK button 355 of the deletion end confirmation screen 354 is depressed by the user to discriminate whether or not the deletion end is confirmed. The CPU 131 stands by until it is discriminated that the deletion end is confirmed by the user.

Then, if it is discriminated that the user depresses the OK button 355 to confirm the deletion end, then the CPU 131 returns the processing to step S141 of FIG. 32. At step S141, the CPU 131 changes over the mode to the polling mode 262 and then ends the history deletion process.

Incidentally, if it is discriminated at step S153 of FIG. 33 that the user does not depress the OK button 352 in a state wherein the deletion confirmation screen 351 shown in FIG. 37 is displayed on the LCD unit 28 and hence an instruction to delete a history is not issued, then the CPU 131 advances the processing to step S157. At step S157, the CPU 131 discriminates whether or not an instruction to suspend the deletion is issued by the user.

If it is discriminated that the cancel button 353 on the deletion confirmation screen 351 shown in FIG. 37 is not depressed and hence an instruction to suspend deletion is not issued, then the CPU 131 returns the processing to step S153 so that the processes at the steps beginning with step S153 are repetitively executed.

In particular, the CPU 131 stands by until the user depresses the OK button 352 or the cancel button 353 while repetitively executing the processes at steps S153 and S157 in a state wherein the deletion confirmation screen 351 of FIG. 37 is displayed on the LCD unit 28.

If it is discriminated at step S157 that the user depresses the cancel button 353 to issue an instruction to suspend deletion, the CPU 131 controls the display control section 136 to erase the deletion confirmation screen 351 of FIG. 37. Then, the CPU 131 returns the processing to step S140 of FIG. 32 so that the processes at the steps beginning with step S140 are repetitively executed.

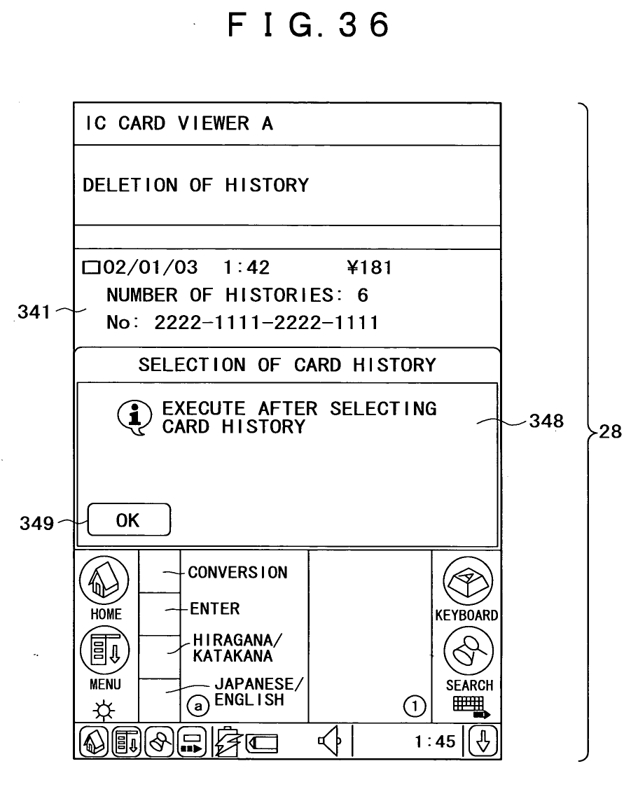

On the other hand, if it is discriminated at step S151 of FIG. 33 after an instruction to delete a history is issued by the user that the deletion candidates have no history, that is, none of the check boxes 343 is in a checked state, then the CPU 131 advances the processing to step S158. At step S158, the CPU 131 controls the display control section 136 to display such a deletion error screen as shown in FIG. 36 on the LCD unit 28.

Referring to FIG. 36, the deletion error screen 348 displayed in an overlapping relationship with the history deletion screen 341 on the LCD unit 28 includes a display of a message “Execute after selecting card history” and an OK button 349 for being depressed by the user for confirmation that an error has occurred.

The CPU 131 having caused the deletion error screen 348 to be displayed now stands by until the user depresses the OK button 349. If the user depresses the OK button 349, then the CPU 131 returns the processing to step S140 of FIG. 32 so that the processes at the steps beginning with step S140 are repetitively executed.

The history deletion process is performed in such a manner as described above in the history deletion mode 265. Consequently, the PDA 1 can delete a history registered in the database in accordance with an instruction of the user.

It is to be noted that the history deletion process described above can be-executed in accordance with an instruction of the user even if the user does not move a contactless IC card 146 so as to be positioned in the proximity of the reader device 37 in the polling mode 262. Consequently, the user can delete history information recorded in the PDA 1 readily.

Further, as described hereinabove, in the history deletion process, the confirmation screen is displayed many times. Consequently, deletion of history information in error by the user can be suppressed, and the operation time can be elongated to suppress an illegal deletion process by a third party.

As described above, the PDA 1 can use the reader device 37 to read out, manage and display history information of a contactless IC card 146 safely and suitably.

It is to be noted that a plurality of applications can be stored into the storage area of the storage section 139 or the like of the PDA 1 as far as the storage capacity of it permits, and the user can select any of the applications so as to be executed as seen in FIG. 2.

In particular, the PDA 1 can store not only the application for managing and displaying history information of the particular contactless IC card 146 described hereinabove but also applications for contactless IC cards 146 of other types.

This allows the user to select an application to be activated in accordance with the type of a contactless IC card 146 and can make the PDA 1 compatible with a plurality of different contactless IC cards 146.

In such an instance, the processes to be executed by the applications corresponding to the types of the contactless IC cards 146 may be different from each other depending upon the type of the contactless IC card 146.

In the following, an application for performing a process different from that of the application described above as the IC card viewer A, that is, an IC card viewer B, is described.

Where the IC card viewer B is executed, the PDA 1 uses the reader device 37 to read history information and so forth stored in a contactless IC card 146 positioned in the proximity thereof and displays only balance information of electronic money charged in the contactless IC card 146, different from that where the IC card viewer A is executed.

Also where the present application, that is, the IC card viewer B, is executed, the CPU 131 changes over the mode thereof among a plurality of modes and executes a process suitable for the mode in the mode.

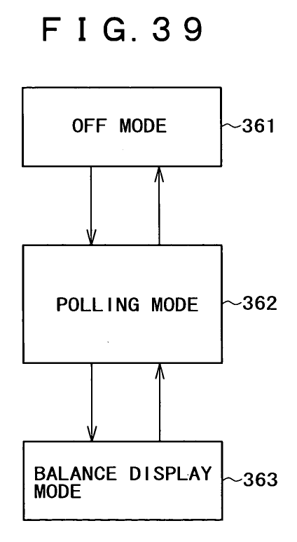

FIG. 39 illustrates a manner of mode transition through execution of the application, that is, the IC card viewer B.

Referring to FIG. 39, the CPU 131 executes the application, that is, the IC card viewer B, and thereupon changes over the mode thereof from an off mode 361 in which the application is not executed to a polling mode 362. In the polling mode 362, the CPU 131 controls the reader device 37 to perform a process of detecting a contactless IC card 146 positioned near to the reader device 37.

Then, in response to an instruction of the user, the PDA 1 enters into a balance display mode 363, in which it controls the LCD unit 28 to display acquired balance information.

Thus, the application, that is, the IC card viewer B, does not have modes corresponding to the history display-storage mode 264 and the history deletion mode 265 different from that of FIG. 9.

In the off mode 361, the power supply to the reader device 37 is off, and the PDA 1 does not perform such a process for communication with a contactless IC card 146 or display of history information on the LCD unit 28.

If, in the off mode 361, the user operates the touch pen 35 to depress the software button 41-11 of the IC card viewer B on such a GUI as shown in FIG. 2 displayed on the LCD unit 28, then the inputting section 137 supplies the information to the CPU 131 through the bus 134. In response to the operation, the CPU 131 reads out and executes an application stored in the storage section 139 or the like and corresponding to the operation, that is, the IC card viewer B.

An activation process executed thereupon by the CPU 131 is similar to the activation process described hereinabove with reference to the flow chart of FIG. 10, and therefore, overlapping description thereof is omitted herein to avoid redundancy.

In short, upon activation of the application, that is, the IC card viewer B, the CPU 131 performs an initialization process of the reader device 37. When the initialization process is completed normally, the CPU 131 enters into the polling mode. However, if the initialization process results in failure, then the CPU 131 causes an error screen to be displayed and ends the application, that is, the IC card viewer B.

The CPU 131 of the PDA 1 having changed over the mode from the off mode 361 to the polling mode 362 of FIG. 39 through such an activation process as described above now performs a process of detecting a contactless IC card 146 positioned near to the reader device 37.

A polling process executed in the polling mode 362 is basically similar to that described hereinabove with reference to the flow charts of FIGS. 12 and 13.

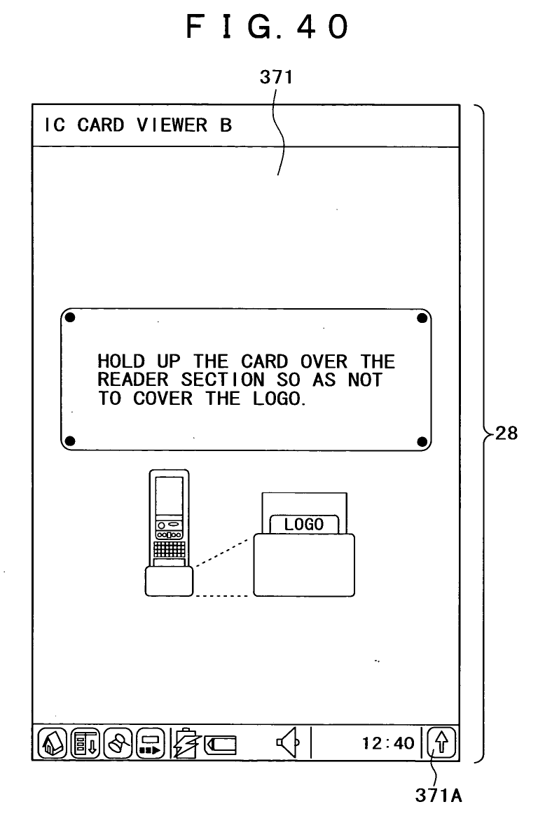

In particular, first at step S21, the CPU 131 controls the display control section 136 to display such an initial screen 371 as shown in FIG. 40 on the LCD unit 28.

Referring to FIG. 40, the initial screen 371 includes a display of a message “Hold up the card over the reader section so as not to cover the logo”. Thus, the user will move the contactless IC card 146 so as to be positioned near to the reader device 37 in accordance with the message.

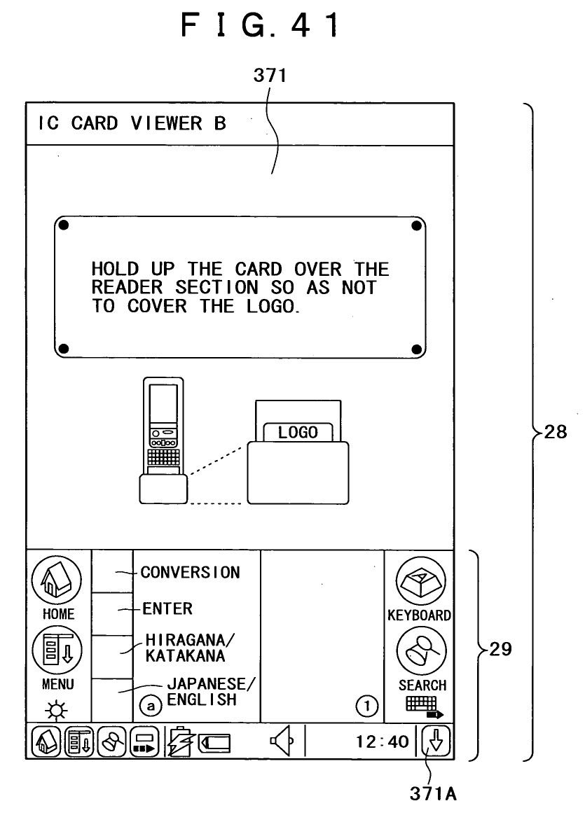

It is to be noted that a display changeover button 371A having an upwardly directed arrow mark thereon is displayed at a lower right corner of the initial screen 281. If the user depresses the display changeover button 371A, that is, if the user taps at the display changeover button 371A using the touch pen 35, then the CPU 131 controls the display control section 136 to change over the display size of the initial screen 371 so that the initial screen 371 and a character input area 29 can be displayed simultaneously as shown in FIG. 41.

If the user depresses the display changeover button 371A having the downwardly directed arrow mark in the state of FIG. 41, then the CPU 131 controls the display control section 136 to display the initial screen 371 on the LCD unit 28 in such a state as seen in FIG. 40.

The CPU 131 having caused such an initial screen 371 as described hereinabove to be displayed now controls, at step S22 of FIG. 12, the reader device 37 to output an IC card detection signal toward the contactless IC card 146 positioned in the proximity of the reader device 37 on the face 13-1.

At step S23, the CPU 131 discriminates whether or not a communicatable contactless IC card 146 is present within a communication range thereof. If it is discriminated that a communicatable contactless IC card 146 is present, then the CPU 131 advances the processing to step S24, at which it supplies an encryption key (decryption key) corresponding to the type of the IC card of an object of the application and issues a request for IC card information.

At step S24, the CPU 131 supplies an encryption key (decryption key) for the type of an object of the application, that is, the IC card viewer B, to the nearly positioned contactless IC card 146 and issues a request for IC card information. The IC card information is information relating to the contactless IC card 146 including an ID number applied to the individual contactless IC card 146 and so forth.

The contactless IC card 146 receives the request for IC card information and uses, if it is of the type compatible with the application, the encryption key (decryption key) supplied thereto from the reader device 37 to decrypt the IC card information thereof stored in an encrypted form therein. Then, the contactless IC card 146 supplies the decrypted IC card information to the reader device 37.

If the contactless IC card 146 positioned near to the reader device 37 is of a type which is not compatible with the application, it cannot use the encryption key (decryption key) acquired from the reader device 37 to decrypt the IC card information stored in an encrypted form therein. Therefore, the contactless IC card 146 cannot respond to the request for IC card information from the reader device 37 or performs an error response.

In response to such a response from the contactless IC card 146 as described above or to presence or absence of a response, the CPU 131 discriminates at step S25 of FIG. 12 whether or not the nearly positioned contactless IC card 146 is a card of the type which makes an object of the application. If the CPU 131 discriminates based on the IC card information supplied from the contactless IC card 146 and acquired by the reader device 37 that the contactless IC card 146 is of the type of the object, it advances the processing to step S26. At step S26, the CPU 131 controls the reader device 37 to acquire history information including balance information regarding a balance of the electronic money and so forth from the contactless IC card 146.

Then at step S27, the CPU 131 switches off the power supply to the reader device 37 having completed the communication process. Then at step S28, the CPU 131 changes over the mode thereof from the polling mode 362 at present to a balance display mode 363 and ends the polling process.

If it is discriminated at step S25 that the nearly positioned contactless IC card 146 is an IC card of a type which does not make an object of the application because a response to the request for IC card information is not received from the nearly positioned contactless IC card 146 or an error response is received, then the CPU 131 advances the processing to step S29. At step S29, the CPU 131 supplies an encryption key (decryption key) for another type which does not make an object in a similar manner as at step S24 to issue a request for IC card information of the incompatible type. It is to be noted that, if a request for IC card information of a plurality of card types is issued, then the process at step S29 is repeated for the different types.

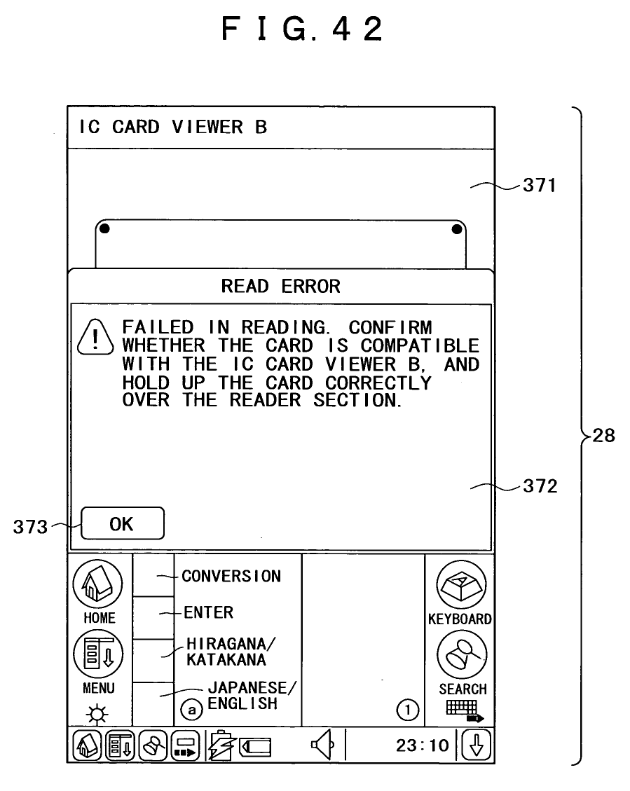

If it is discriminated, at step S30, based on the response to the process described above from the contactless IC card 146 that the contactless IC card 146 is of a type which does not make an object, then the CPU 131 advances the processing to step S31, at which it switches off the power supply to the reader device 37 having ended the communication process. Then at step S32, the CPU 131 controls the LCD unit 28 to display such a read error screen as shown in FIG. 42.

Referring to FIG. 42, a read error screen 372 is displayed in an overlapping relationship with the initial screen 371 on the LCD unit 28. The read error screen 372 displays a message “Failed in reading. Confirm whether the card is compatible with the IC card viewer B, and hold up the card correctly over the reader section” and an OK button 373 to be depressed after confirmation by the user.

Referring back to FIG. 12, the CPU 131 controls the touch panel 36 to discriminate whether or not the user depresses the OK button 373 at step S33 and then stands by until after it is discriminated that the OK button 373 is depressed.

If it is discriminated that the user depresses the OK button 373 confirming the read error, then the CPU 131 switches on the power supply to the reader device 37 at step S34 and then returns the processing to step S22 so that the processes at the steps beginning with step S22 are repetitively executed.

If it is discriminated at step S23 that no communicatable IC card is present, then the CPU 131 advances the processing to step S41 of FIG. 13, at which it discriminates whether or not a predetermined period of time elapses.

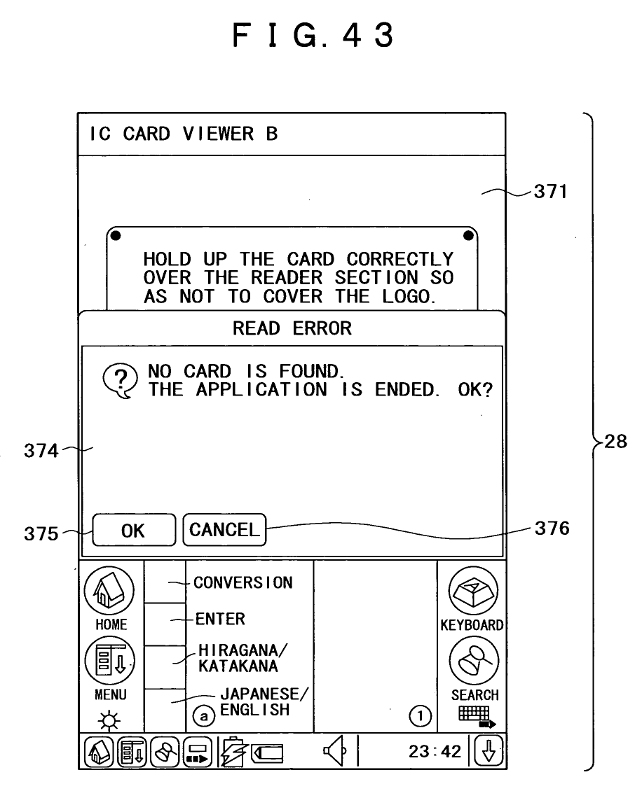

If it is discriminated that the predetermined period of time elapses, then the CPU 131 advances the processing to step S42, at which it switches off the power supply to the reader device 37. Then at step S43, the CPU 131 controls the LCD unit 28 to display such a card detection error screen as shown in FIG. 43.

Referring to FIG. 43, the LCD unit 28 displays the card detection error screen 374 in an overlapping relationship with the initial screen 371. The card detection error screen 374 includes a display of a message “No card is found. The application is ended. OK?”, and an OK button 375 and a cancel button 376. The OK button 375 is depressed by the user when the user tries to end the application, that is, the IC card viewer B. The cancel button 376 is depressed by the user when the user tries to cancel such ending of the application.

Referring back to FIG. 13, at step S44, the CPU 131 controls the touch panel 36 to discriminate whether or not the user depresses the OK button 375 of FIG. 43 to issue an instruction to end the application. If it is discriminated that an instruction to end the application is issued, then the CPU 131 ends the application at step S45 and places itself into the off mode 361 and then ends the polling process.

On the other hand, if it is discriminated at step S44 that an instruction to end the application is not issued because the user does not depress the OK button 375, then the CPU 131 advances the processing to step S46. At step S46, the CPU 131 discriminates whether or not the user depresses the cancel button 376 to cancel the ending of the application and issues an instruction to resume the polling. If it is discriminated that the user does not depress the cancel button 376 and therefore does not issue an instruction to resume the polling, then the processing returns the processing to step S44 so that the processes at the steps beginning with step S44 are repetitively executed. Then, if it is discriminated at step S46 that the user depresses the cancel button 376 to resume the polling, then the CPU 131 returns the processing to step S34 of FIG. 12 so that the processes at the steps beginning with step S34 are repetitively executed.

In particular, the CPU 131 stands by until the user operates the OK button 375 or the cancel button 376 on the card detection error screen 374 of FIG. 43. Then, if the OK button 375 or the cancel button 376 is depressed, then the CPU 131 executes a process based on an instruction corresponding to the depressed button.

It is to be noted that, if the CPU 131 discriminates at step S30 of FIG. 12 that the contactless IC card 146 positioned near to the reader device 37 is not of a type which does not make an object of the application, then it advances the processing to step S42 of FIG. 13 so that the processes at the steps beginning with step S42 are repetitively executed.

On the other hand, if it is discriminated at step S41 that the predetermined time does not elapse, then the CPU 131 returns the processing to step S22 of FIG. 12 so that the processes at the steps beginning with step S22 are repetitively executed.

Since the IC card viewer B does not involve the history deletion mode as described hereinabove with reference to FIG. 39, the processes at steps S47 to S49 in FIG. 13 are omitted.

In particular, the CPU 131 waits until a communicatable IC card is detected while outputting an IC card detection signal in the polling process. If a communicatable IC card is not detected for a predetermined period of time, then the CPU 131 controls the LCD unit 28 to display the card detection error screen 374 and accepts an instruction of the user.

On the other hand, if a communicatable IC card is detected, then the CPU 131 discriminates the type of the IC card. If the IC card is of a type compatible with the application, then the CPU 131 acquires history information from the contactless IC card 146 and then enters into the balance display mode 363.

If it is discriminated that the nearly positioned contactless IC card 146 is not compatible with the application, then the CPU 131 controls the LCD unit 28 to display the read error screen 372 and accepts an instruction of the user.

In particular, the CPU 131 executes a process suitable for the type of the IC card such as to control the LCD unit 28 to display a screen which differs depending upon the type of the contactless IC card 146 detected by the reader device 37. Consequently, if an error occurs, then the CPU 131 can control the LCD unit 28 to display a cause of the error in detail. Consequently, the user can recognize readily what has been inappropriate.

Further, in order to activate an application in the off mode 361 in which no application is activated as seen in FIG. 39 so that a process for displaying a balance hereinafter described and other necessary processes are executed, the user must cause such a polling process as illustrated in the flow charts of FIGS. 12 and 13 to be performed in the polling mode 362 to detect a legal contactless IC card 146.

This can suppress a third party from illegally accessing history information of a contactless IC card 146.

The CPU 131 having entered into the balance display mode 363 from the polling mode 362 of FIG. 39 now executes a balance display process of displaying the latest balance information of electronic money charged in the contactless IC card 146 based on the acquired history information.

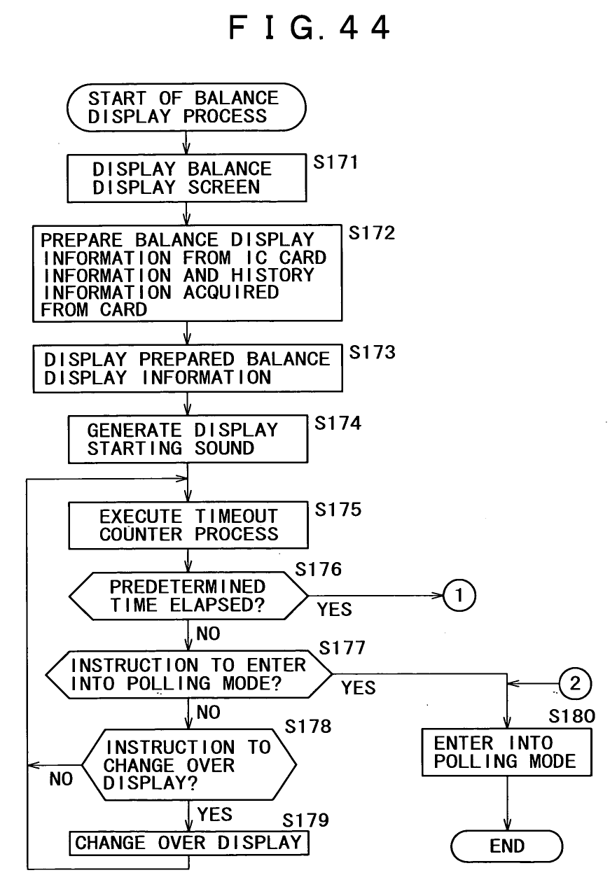

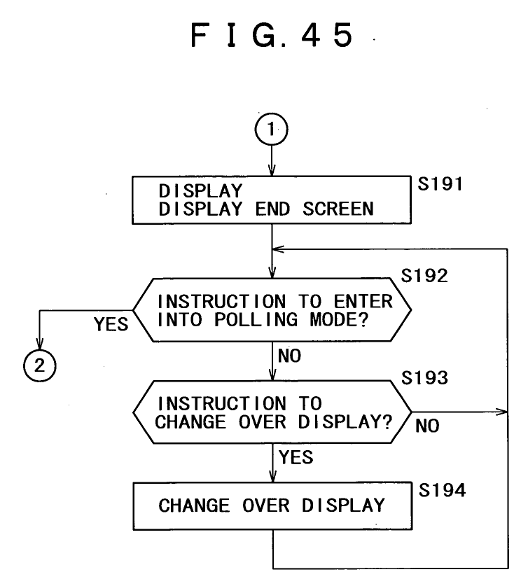

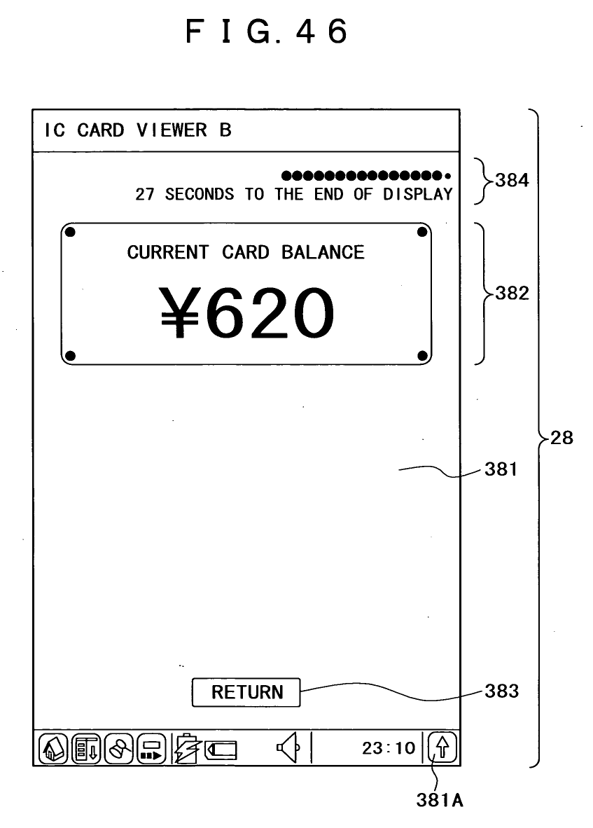

The balance display process by the PDA 1 is described below with reference to the flow charts of FIGS. 44 and 45. Also FIGS. 46 to 49 are referred to as occasion demands.

First at step S171, the CPU 131 controls the LCD unit 28 to display such a balance display screen as shown in FIG. 46. At step S172, the CPU 131 produces balance display information to be displayed on the balance display screen based on the IC card information and the history information acquired from the contactless IC card 146 positioned near to the reader device 37. Then at step S173, the CPU 131 controls the display control section 136 to display the produced balance display information on the balance display screen, and at step S174, the CPU 131 controls the speaker to output predetermined display starting sound prepared in advance.

Referring to FIG. 46, the balance display screen 381 displayed on the LCD unit 28 includes a display of IC card balance information 382 based on the history information acquired by the process at step S26 of FIG. 12. The IC card balance information 382 relates to the balance (current card balance ¥620) of electronic money charged in the nearly positioned contactless IC card 146. From the display, the user can grasp the current balance of electronic money of the contactless IC card 146.

The balance display screen 381 further includes a display of a return button 383 for being depressed or tapped by the user to issue an instruction to enter into the polling mode. It is to be noted that, since the IC card viewer B does not involve management or display of history information of commercial transactions as described hereinabove, the balance display screen 381 does not include a display of a button corresponding to the history button 294 of the balance display screen 291 of FIG. 20.

A timeout counter 384 indicative of the remaining display time of the balance display screen 381 is displayed at an upper portion of the balance display screen 381. The balance display screen 381 is displayed only for a predetermined period of time, for example, 30 seconds. The timeout counter 384 includes an indicator whose display changes every time the remaining display time decreases, and a message “T seconds to the end of display”. Here, T is the remaining time and is represented, in the case of the example of FIG. 46, in a unit of second. From the display of the timeout counter 384, the user can grasp the remaining display time of the balance display screen 381.

As hereinafter described, the user will depress the return button 383 to issue an instruction to enter into the polling mode within a predetermined period of time, for example, 30 seconds, after such a balance display screen 381 as described hereinabove is displayed. When the display time of the balance display screen 381 exceeds the predetermined time such as 30 seconds, the LCD unit 28 displays such a display end screen as hereinafter described.

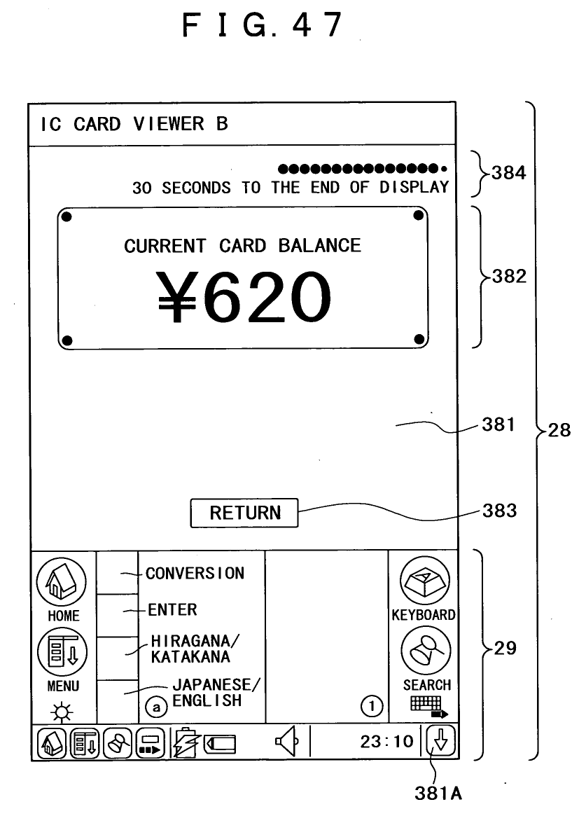

It is to be noted that a display changeover button 381A having an upwardly directed arrow mark is displayed at the right lower corner of the LCD 28 of FIG. 46. If the user depresses or taps at the display changeover button 381A, then the display size of the balance display screen 381 being displayed is changed over. If, in the state of FIG. 46, the user depresses the display changeover button 381A, then the CPU 131 controls the display control section 136 to change over the display size of the balance display screen 381 so that the balance display screen 381 and a character input area 29 are displayed simultaneously on the LCD unit 28 as seen in FIG. 47.

If, in such a state as seen in FIG. 47, the user depresses the display changeover button 381A of a downwardly directed arrow mark, that is, the user taps at the display changeover button 381A of the LCD unit 28, then the CPU 131 controls the display control section 136 to change over the display size of the balance display screen 381 to that as seen in FIG. 46.

Referring back to FIG. 44, after the CPU 131 causes such a balance display screen 381 as described above to be displayed through the processes at steps S171 to S174, it advances the processing to step S175. At step S175, the CPU 131 executes a timeout counter process for controlling the display of the timeout counter 384 of the balance display screen 381 to perform a process relating to counting of the display time.

Then at step S176, the CPU 131 discriminates whether or not a predetermined period of time, for example, 30 seconds elapses. If it is discriminated that the predetermined time does not elapse, then the CPU 131 advances the processing to step S177.

At step S177, the CPU 131 discriminates whether or not an instruction to enter into the polling mode 362 is issued by the user. If the CPU 131 discriminates that the user does not depress the return button 383 of FIG. 46 (or FIG. 47), that is, the user does not tap at the return button 383 of the LCD unit 28 and hence an instruction to enter into the polling mode 362 is not issued, then the processing advances to step S178.

At step S178, the CPU 131 discriminates whether or not an instruction to change over the display of the balance display screen 381 is issued by the user. If it is discriminated that the user depresses the display changeover button 381A in FIG. 46 (or FIG. 47), that is, taps at the display changeover button 381A of the LCD unit 28 and hence an instruction to change over the display of the balance display screen 381 is issued, then the processing advances to step S179. At step S179, the CPU 131 changes over the display size of the balance display screen 381 as described hereinabove. Thereafter, the CPU 131 returns the processing to step S175 so that the processes at the steps beginning with step S175 are repetitively executed.

If it is discriminated at step S178 that the user does not depress the display changeover button 381A of FIG. 46 (or FIG. 47) and hence an instruction to change over the display of the balance display screen 381 is not issued, then the CPU 131 omits the process at step S179 and returns the processing to step S175 so that the processes at the steps beginning with step S175 are repetitively executed.

As described above, the CPU 131 controls the display control section 136 to repeat the processes at steps S175 to 179 to cause the LCD unit 28 to display the balance display screen 381 for a predetermined period of time, for example, 30 seconds.

On the other hand, if it is discriminated at step S177 that the user depresses the return button 383 of FIG. 46 (or FIG. 47), that is, taps at the return button 383 of the LCD unit 28 and hence an instruction to enter into the polling mode 362 is issued, then the CPU 131 advances the processing to step S180. At step S180, the CPU 131 changes over the mode from the balance display mode 363 of FIG. 39 which is a current mode to the polling mode 362 and then ends the balance display process.

If it is discriminated at step S176 that a predetermined period of time elapses after the balance display screen 381 is displayed for a predetermined period of time in such a manner as described above, then the CPU 131 advances the processing to step S191 of FIG. 45.

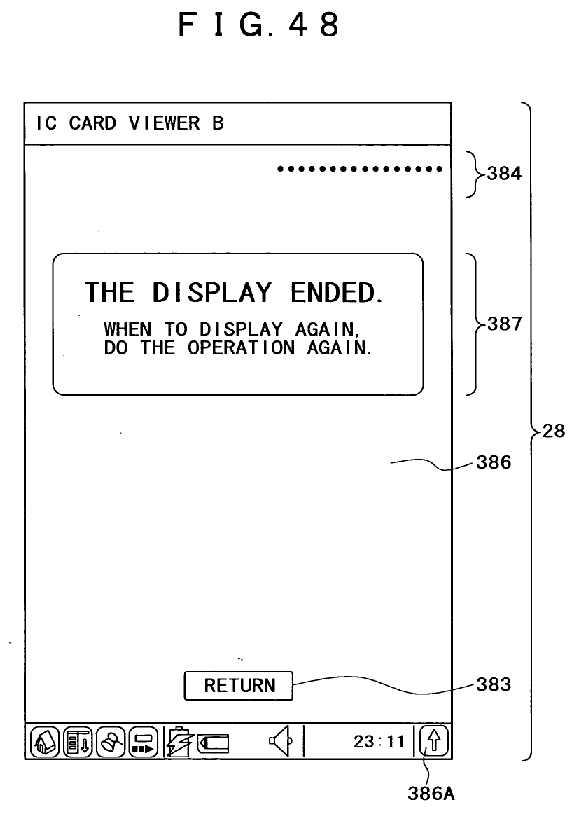

At step S191 of FIG. 45, the CPU 131 controls the LCD unit 28 to display such a display end screen as shown in FIG. 48 in place of the balance display screen 381 having been displayed on the LCD unit 28.

Referring to FIG. 48, the display end screen 386 displayed on the LCD unit 28 includes a display of a message 387 “The display ended. When to display again, do the operation again”. From the message 387, the user can grasp that the balance display is ended and can recognize what operation should be performed subsequently.

The display end screen 386 includes, in addition to the display of the message 387, a display of a return button 383 and a timeout counter 384. The timeout counter 384 is displayed in a timeout state.

The user will confirm on the display end screen 386 that the display of the balance display screen 381 comes to an end, and depress the return button 383 to issue an instruction to enter into the polling mode 362.

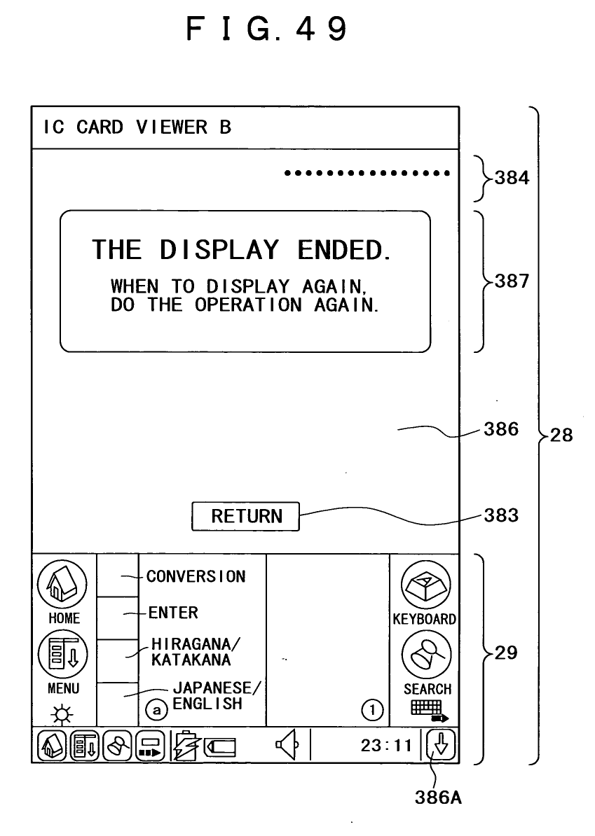

It is to be noted that a display changeover button 386A is displayed at a right lower end of the LCD unit 28 of FIG. 48. The display changeover button 386A is used to change over the display size of the display end screen 386. In the state of FIG. 48, an upwardly directed arrow mark is displayed on the display changeover button 386A. If the display changeover button 386A is depressed, then the CPU 131 controls the display control section 136 to change over the display size of the display end screen 386 to such a display size as shown in FIG. 49 so that the display end screen 386 and a character input area 29 may be displayed simultaneously on the LCD unit 28.

If the user depresses the display changeover button 386A having a downwardly directed arrow mark in the state of FIG. 49, then the CPU 131 controls the display control section 136 to change over the display size of the display end screen 386 to such a size of a display as seen in FIG. 48.

In other words, every time the user depresses the display changeover button 386A, the display size of the display end screen 386 changes such that it is changed over alternately between the display sizes as seen in FIGS. 48 and 49.

Referring back to FIG. 45, after the CPU 131 controls the LCD unit 28 to display such a display end screen 386 as described above through the process at step S191, it discriminates at step S192 whether or not an instruction to enter into the polling mode 362 is issued by the user.

If it is discriminated that the user does not depress the return button 383 of FIG. 48 (or FIG. 49) and hence an instruction to enter into the polling mode 362 is not issued, then the CPU 131 advances the processing to step S193 while keeping the mode in the balance display mode 363. At step S193, the CPU 131 discriminates whether or not an instruction to change over the display is issued by the user.

If it is discriminated that the user depresses the display changeover button 386A of FIG. 48 (or FIG. 49), that is, the user taps at the display changeover button 386A of the LCD 28 to issue an instruction to change over the display size of the display end screen 386, then the CPU 131 controls the display control section 136 to change over the display size of the display end screen 386 displayed on the LCD unit 28 at step S194. In particular, if the display size of the display end screen 386 is in such a state of FIG. 48, then it is changed over to the state of FIG. 49, but if the display of the display end screen 386 is in such a state of FIG. 49, then it is changed over to the state of FIG. 48 conversely. Then, the CPU 131 returns the processing to step S192 so that the processes at the steps beginning with step S192 are repetitively executed.

If it is discriminated at step S193 that an instruction to change over the display is not issued, then the CPU 131 omits the process at step S194 and returns the processing to step S192 so that the processes at the steps beginning with step S192 are repetitively executed.

The CPU 131 stands by until the user depresses the return button 383 while repetitively executing the processes at steps S192 to S194 in such a manner as described above.

If it is discriminated at step S192 that the user depresses the return button 383, that is, the user taps at the return button 383 of the LCD unit 28 to issue an instruction to enter into the polling mode 362, then the CPU 131 advances the processing to step S180 of FIG. 44. At step S180, the CPU 131 changes over the mode from the balance display mode 363 of FIG. 39 which is a current mode to the polling mode 362 and then ends the balance display process.

The CPU 131 executes such a balance display process as described above in the balance display mode of FIG. 39 to control the LCD unit 28 to display the balance information of the contactless IC card 146 positioned in the proximity of the reader device 37 for a predetermined period of time, for example, 30 seconds in such a manner as described above. Then, when the predetermined period of time elapses, the CPU 131 controls the display control section 136 to display the display end screen 386 in place of the balance display screen 381 on the LCD unit 28.

As a result, even when the user operates a contactless IC card 146 so as to be positioned near to the reader device 37 in the polling mode 362 so that IC card information or/and history information are read into the PDA 1, balance information is displayed only for a predetermined period of time. Therefore, for example, such a situation that, while balance information remains displayed, the user leaves the PDA 1 to allow a third party to read the balance information can be prevented.

Since the display time of the balance display screen 381 displayed in the balance display mode 363 is limited, the PDA 1 can safely display IC card information and history information of the contactless IC card 146 read in in the polling mode 362.

As described above, also in the present application, that is, in the IC card viewer B, the PDA 1 can use the reader device 37 to read out and display history information of a contactless IC card 146 safely and suitably.

In particular, the PDA 1 can execute an object application selected by the user from among a plurality of applications stored in the storage section 139 or the like to perform processes suitable for a plurality of different contactless IC cards 146 and can further perform different processes using a contactless IC card 146.

It is to be noted that, while, in the foregoing description, the user selects an application to be activated, the method of selection of an application is not limited to this. Alternatively, for example, the PDA 1 may be configured such that it discriminates the type of a nearly positioned contactless IC card 146 in the polling mode and selects and activates an application suitable for the nearly positioned contactless IC card 146 based on a result of the discrimination.

It is described hereinabove with reference to the flow charts of FIGS. 12 and 13 that the CPU 131 of the PDA 1 can detect a plurality of different types of contactless IC cards 146 in the polling process and can perform a different process depending upon the type of the detected contactless IC card 146 to display a different screen.

Similarly, if the CPU 131 performs a different process depending upon the detected type of a contactless IC card 146 to activate a different application, then the PDA 1 can select and activate an application corresponding to the nearly positioned contactless IC card 146.

After a selected application is activated in such a manner as described above, a process similar to that described hereinabove may be performed, and therefore, overlapping description thereof is omitted herein to avoid redundancy.

At present, unified specifications for contactless IC cards are not available, and they adopt different communication methods and so forth depending upon the makers thereof. However, if ID numbers having unified specifications are applied to contactless IC cards of different companies, then also it is possible for the PDA 1 to activate an application compatible with a contactless IC card 146 of a different company. Also a process relating to discrimination of the type of a contactless IC card 146 in the polling process described hereinabove with reference to the flow charts of FIGS. 12 and 13 can be performed readily.

In particular, in the polling process described hereinabove with reference to the flow charts of FIGS. 12 and 13, the CPU 131 first discriminates whether or not a communicatable contactless IC card 146 is detected. If a communicatable contactless IC card 146 is detected, then the CPU 131 discriminates the type of the contactless IC card 146. However, where an ID number having common specifications is applied to the contactless IC card 146, the CPU 131 can detect that an contactless IC card 146 is positioned in the proximity and can discriminate also the type of the contactless IC card 146 only by acquiring the ID number of the contactless IC card 146 from the contactless IC card 146.

It is to be noted that, in the foregoing description, the PDA 1 is used to manage and display history information of a contactless IC card 146. However, any information processing apparatus can be used only if it has such a configuration as described hereinabove and can execute such a series of processes as described hereinabove. For example, a mobile terminal such as a notebook type personal computer, a portable telephone set, a personal computer, a household electric appliance may be used.

Further, in the foregoing description, a contactless IC card is used as an IC card whose history information is to be referred to. However, the IC card is not limited to the contactless IC card, but may otherwise be a contact type IC card. Further, while, in the foregoing description, the information read out from a contactless IC card 146, managed and displayed by the PDA 1 is history information of commercial transactions for which a contactless IC card 146 is used, it is not limited to such history information but may be any information only if it is stored in a contactless IC card 146.

Furthermore, in the PDA 1 described above, the memory to be loaded into the slot 64 is a memory card 143. However, the memory is not limited to this but may be any recording medium only if it can be loaded into the slot 64. For example, though not shown, some other semiconductor memory unit, a magnetic disk, an optical disk, and a magneto-optical disk may be used instead.

It is to be noted that, where the series of processes is executed by software, a program which constructs the software is installed from a network or a recording medium into the PDA 1. However, the recording medium may not only be loaded directly into the PDA 1 but may otherwise be loaded into a different apparatus as occasion demands. In this instance, the different apparatus and the PDA 1 communicate with each other to install the program from the different apparatus into the PDA 1.

The recording medium may be formed as a package medium, for example, a semiconductor memory such as the memory card 143 which has the program recorded thereon or therein and is distributed in order to provide the program to a user separately from a computer as shown in FIG. 5, or, though not shown, a magnetic disk (including a floppy disk), an optical disk (including a CD-ROM (Compact Disc-Read Only Memory) and a DVD (Digital Versatile Disk)), or a magneto-optical disk (including an MD (Mini-Disc)). Further, the recording medium is formed from the ROM 132 or the storage section 139 in the form of a hard disk which has the program stored therein or thereon and is provided to a user in a form wherein it is incorporated in an apparatus body in advance.

It is to be noted that, in the foregoing description, the processes indicated by the flow charts are executed as software by the CPU 131 shown in FIG. 5. However, naturally it is possible to prepare hardware for executing the individual process so that the processes may be executed by the hardware.

Further, in the present specification, the steps which describe the program recorded on a recording medium may be but not necessarily be processed in a time series in the order as described, and include processes which are executed parallelly or individually without being processed in a time series.

While a preferred embodiment of the present invention has been described using specific terms, such description is for illustrative purposes only, and it is to be understood that changes and variations may be made without departing from the spirit or scope of the following claims.

What is claimed is:

1. An information processing apparatus which communicates with an IC card, on which information can be recorded, to read out information recorded in the IC card, comprising:
information acquisition means for acquiring said information recorded in said IC card;
information storage means for storing said information acquired by said information acquisition means;
information processing means for performing a predetermined process for said information; and
information display control means for controlling display of said information acquired by said information acquisition means.

2. An information processing method for an information processing apparatus which communicates with an IC card, on which information can be recorded, to read out information recorded in the IC card, comprising:
an information acquisition step of acquiring said information recorded in said IC card;
an information storage step of storing said information acquired by said process of said information acquisition step;
an information processing step of performing a predetermined process for said information; and
an information display control step of controlling display of said information acquired by said process of said information acquisition step.

3. A program for causing a computer to perform a process of communicating with an IC card, on which information can be recorded, to read out information recorded in the IC card, the program comprising:
an information acquisition step of acquiring said information recorded in said IC card;
an information storage step of storing said information acquired by said process of the information acquisition step;
an information processing step of performing a predetermined process for said information; and
an information display control step of controlling display of the information acquired by said process of said information acquisition step.

4. An information processing apparatus which communicates with an IC card, on which information can be recorded, to read out information recorded in the IC card, comprising:
IC card detection means for detecting said IC card which is in a communicatable state;
type detection means for detecting a type of said IC card detected by said IC card detection means;
information acquisition means for acquiring the information stored in said IC card if a result of said discrimination by said type discrimination means indicates that said IC card is a legal type card; and
information display control means for controlling display of said information acquired by said information acquisition means.

5. An information processing apparatus according to claim 4, wherein said IC card is a contactless IC card which communicates with a communication apparatus positioned in the proximity thereof.

6. An information processing apparatus according to claim 4, wherein said detection means includes detection signal outputting means for outputting a predetermined detection signal, and response acquisition means for acquiring a response to said detection signal supplied from said IC card to said information processing apparatus and outputted from said detection signal outputting means, said detection means detecting the IC card which is in a communicatable state through acquisition of said response by said response acquisition means.

7. An information processing apparatus according to claim 4, wherein the information includes identification information of said IC card and balance information of electronic money recorded in said IC card.

8. An information processing apparatus according to claim 7, wherein the information recorded in the IC card is information encrypted using a suitable one of encryption keys different among different types with regard to the IC card, and said information processing apparatus further comprising:
identification information requesting means for issuing a request for the identification information of said IC card;
decryption key supplying means for supplying a decryption key corresponding to the encryption key for being used to decrypt said information to said IC card; and
identification information acquisition means for acquiring the identification information of said IC card decrypted by said IC card using said decryption key supplied from said decryption key supplying means;
said type discrimination means discriminating the type of said IC card based on said type of said decryption key used for the decryption of said identification information of said IC card acquired by said identification information acquisition means.

9. An information processing apparatus according to claim 7, wherein said information display control means controls display of said information so that said information may be displayed for a predetermined period of time.

10. An information processing apparatus according to claim 9, further comprising remaining time counting means for counting remaining display time when said information is displayed for said predetermined period of time under the control of said information display control means.

11. An information processing apparatus according to claim 10, wherein said information display control means causes said remaining display time counted by said remaining time counting means to be displayed together with said information.

12. An information processing apparatus according to claim 11, wherein said information display control means causes said remaining display time to be displayed in the form of an indicator or a message.

13. An information processing apparatus according to claim 12, further comprising sound outputting means for outputting predetermined sound in synchronism with a start of display of said information under the control of said information display control means to issue a notification of said start of display of said information.

14. An information processing method for an information processing apparatus which communicates with an IC card, on which information can be recorded, to read out information recorded in the IC card, comprising:
an IC card detection step of detecting said IC card which is in a communicatable state;
a type discrimination step of discriminating a type of said IC card detected by the process of the IC card detection step;
an information acquisition control step of acquiring said information stored in said IC card if a result of said discrimination by the process of the type discrimination step indicates that said IC card is a legal type card; and
an information display control step of controlling display of said information acquired by said process of said information acquisition control step.

15. A program for causing a computer to communicate with an IC card, on which information can be recorded, to read out information recorded in the IC card, the program comprising:
an IC card detection step of detecting said IC card which is in a communicatable state;
a type discrimination step of discriminating a type of the IC card detected by the process of the IC card detection step;
an information acquisition control step of acquiring the information stored in said IC card if a result of the discrimination by the process of said type discrimination step indicates that said IC card is a legal type card; and
an information display control step of controlling display of said information acquired by the process of said information acquisition control step.

16. An information processing apparatus which communicates with an IC card, on which information can be recorded, to read out information recorded in the IC card, comprising:
information acquisition means for acquiring said information recorded in said IC card;
information storage means for storing said information acquired by said information acquisition means;
information management control means for managing said information stored in said information storage means as information of said individual IC card and controlling readout and writing of said information from and into said information storage means; and
information display control means for controlling display of said information.

17. An information processing apparatus according to claim 16, further comprising:
IC card detection means for detecting the IC card which is in a communicatable state; and
type discrimination means for discriminating a type of the IC card detected by said IC card detection means;
said information acquisition means acquiring said information stored in said IC card if a result of the discrimination by said type discrimination means indicates that said IC card is a legal type card.

18. An information processing apparatus according to claim 17, wherein said detection means includes detection signal outputting means for outputting a predetermined detection signal, and response acquisition means for acquiring a response to the detection signal supplied from the IC card to said information processing apparatus and outputted from said detection signal outputting means, said detection means detecting the IC card which is in a communicatable state through acquisition of said response by said response acquisition means.

19. An information processing apparatus according to claim 16, further comprising:
encryption means for encrypting said information in accordance with a predetermined method; and
decryption means for decrypting said information encrypted by said encryption means in accordance with a method corresponding to the method of encryption by said encryption means;
said information management control means writes said information encrypted by said encryption means into said information storage means;
said decryption means decrypting said encrypted information read out from said information storage means by said information management control means.

20. An information processing apparatus according to claim 16, further comprising sound outputting means for outputting predetermined sound in synchronism with a start of display of said information under the control of said information display control means to issue a notification of the start of display of said information.

21. An information processing apparatus according to claim 16, wherein said information includes identification information of said IC card, balance information of electronic money recorded in said IC card, and history information which is information relating to a history of commercial transactions performed using said IC card.

22. An information processing apparatus according to claim 21, wherein said information management control means uses the identification information of said IC card included in said information to manage said information for said individual IC card.

23. An information processing apparatus according to claim 22, wherein, when said information management control means writes first information which is a new version of the information into said information storage means, said information management control means updates, where second information which is the information corresponding to the identification information of said IC card same as that of said first information is present in said information storage means, the second information with the first information, but writes, when the second information is not present in said information storage means, the first information newly into said information storage means.

24. An information processing apparatus according to claim 21, wherein said information display control means controls said balance information included in said information so as to be displayed for a predetermined period of time, said information processing apparatus further comprising request acceptance means for accepting a request regarding display of said history information included in said information for the period of time within which said balance information is displayed under the control of said information display control means, said information display control means causing, when said request is accepted by said request acceptance means, said history information corresponding to said IC card identification information same as that of said displayed balance information to be displayed.

25. An information processing apparatus according to claim 24, further comprising history information production means for producing the latest history information based on said information acquired by said information acquisition means and said information read out from said information storage means by said information management control means, said information display control means causing the latest history information produced by said history information production means to be displayed.

26. An information processing apparatus according to claim 25, wherein said information display control means causes said history information which is not included in said information read out from said information storage means from within said latest history information produced by said history information production means to be displayed with a predetermined mark added thereto.

27. An information processing method for an information processing apparatus which communicates with an IC card, on which information can be recorded, to read out information recorded in the IC card, comprising:
an information acquisition control step of managing said information acquisition recorded in the IC card;
an information management control step of managing said information acquired under the control of the process of said information acquisition control step and stored in a storage section of said information processing apparatus as information of the individual IC card and controlling readout and writing of said information from and into said storage section; and
an information display control step of controlling display of said information.

28. A program for causing a computer to communicate with an IC card, on which information can be recorded, to read out information recorded in the IC card, the program comprising:
an information acquisition control step of acquiring said information recorded in the IC card;
an information management control step of managing said information acquired under the control of the process of the information acquisition control step and stored in a storage section of said information processing apparatus as information of said individual IC card and controlling readout and writing of the information from and into said storage section; and
an information display control step of controlling display of said information.
